(19) United States
(12) Patent Application Publication
(10) Pub. No.: US 2007/0166684 A1
(43) Pub. Date: Jul. 19, 2007

(54) System and method for creating a writing

(76) Inventor: Harriette L. Walker, Plattsburgh, NY (US)

Correspondence Address: PHILLIPS LYTLE LLP;INTELLECTUAL PROPERTY GROUP, 3400 HSBC CENTER, BUFFALO, NY, 14203-3509, US

(21) Appl. No.: 11/646,047

(22) Filed: Dec. 27, 2006

Related U.S. Application Data
(60) Provisional application No. 60/754,147, filed on Dec. 27, 2005.

(51) Int. Cl. G09B 3/00

(52) U.S. Cl. 434/322

(57) ABSTRACT

The present invention provides an improved interactive system and method for creating a writing such as a review, report, essay, analysis or argument, for example, which method and system may be software, internet and/or computer-based. The method and system uses a sequence of primary questions corresponding to a chosen writing type or style and/or secondary question sets corresponding to such primary questions; prompts a user to provide answers to such primary questions and secondary question sets; arranges such answers as a function of the writing type or style selected; whereby a writing or writings are created or generated.

### PRIORITY CLAIM

The present application claims priority to U.S. Provisional Patent Application No. 60/754,147, filed Dec. 27, 2005.

### TECHNICAL FIELD

The present invention relates generally to a system and method for creating a writing such as a review, report, essay, analysis or argument, for example.

### BACKGROUND OF THE INVENTION

In trying to meet a deadline, and otherwise, many writers have found that the “writing process” learned previously creates more anxiety than polished prose, leading some to consider plagiarism, others to write haphazardly, and still others to suffer lasting writer's block.

Methods have been developed previously to assist users in preparing papers or outlines. For example, U.S. Pat. No. 6,572,382 (Tanaka) discloses a method based upon a logical structure table. However, among other things, Tanaka differs from the invention herein because it uses logical structure tables which merely work backwards from a conclusion by repeatedly asking a user for support for such conclusion and “reasons to support the reasons” until such support becomes “self-evident,” thereby creating a hierarchical logic table which allows for “visualization” of the hierarchical relationship between an assertion and reasons of a paper. Among other things, the resulting output of Tanaka is apparently a physical or logical structure which a user may use to create a paper, unlike the method and system of the present invention which results in an actual writing. Other patent and patent applications disclose methods of teaching a writing process, such as U.S. Patent Application Publication No. 2006/0105303 (Ames et al.), which teaches a standard educational approach to a writing process, unlike the method of creating a writing by answering questions, as disclosed herein. Other methods and systems of limited utility are disclosed in U.S. Pat. Nos. 5,897,646 (Suda et al.), 6,077,085 (Parry et al.), 6,254,395 (Breland et al.), 6,796,800 (Burstein et al.), 2003/0048308 (Friedlander), 2004/0250209 (Norcross et al.) and 2006/0123329 (Steen et al.).

There is a need, therefore, for an improved system and method for creating a writing which alleviates or eliminates many of the limitations of the prior art.

### BRIEF SUMMARY OF THE INVENTION

With reference to the corresponding parts and portions of the disclosed embodiment, merely for purposes of illustration and not by way of limitation, the present invention provides an improved system and method for creating a writing. Certain aspects of the invention provide a method for a writer to select a suitable type, style and length of writing. As used herein, the term writing includes a review, report, essay, analysis, argument, composition, comparison, narration, description, exposition, classification, definition, illustration, process, biography, term paper, thesis, dissertation, and other types of writings. Other aspects of the invention provide for the development of such a writing in an orderly, timely, and skillful method; and provide a method and system for a writer to revise that writing or composition, and to supplement it with ancillary matter. In certain aspects of the invention, after a type, style, and length of writing suitable for the user is determined, a set of primary questions is output, and a user inputs answers, preferably in sentence form, thereby creating an outline/abstract of a writing in “preview” (as described and illustrated herein). Next, in another aspect of the invention, the user develops those answers by completing corresponding sets of secondary questions generated by the invention, which form paragraphs; also, in other aspects, a user may input answers to questions sets for creating an introduction, conclusion, and/or for meeting personalized requirements. For instance, a writer may need to document a quotation, paraphrase or summary from a primary or secondary source and the invention incorporates it into the writing. The invention in one aspect previews development of the writing after receiving each answer, and recalculates word count. The invention may also feature a pacing mechanism for completing a question set or a writing or both in a predetermined amount of time, and it may include references in certain aspects (e.g., in the form of hyperlinks), which aid the writer. After completing primary and secondary question sets, a user of the present invention may revise and reorder—for example, adding, deleting, or otherwise changing, editing, and correcting text to create optimal length, typical organization, effective development, obvious coherence, and/or conforming style. Along with creating final copy, a user of certain aspects of the present invention may also opt to create templates for ancillary pages (e.g., a title page or bibliography). The method of the invention may be implemented in many ways, as described herein. For example, certain aspects of the invention provide a series of interactive screens, viewable on a computer monitor or other electronic device, and accessible via a personal computer, laptop or workstation, via the web, via a hand-held wireless or cellular device, and by other methods known to those skilled in the art. One aspect of the invention provides a web-based membership or pay-per-use system which provides interactive screens with questions, prompts and links for users, and accepts/receives input and answers from such user to generate a writing (and, in some aspects, an outline).

Other aspects of the invention include a method and/or system for creating a writing which includes: determining or selecting a desired writing type; generating a plurality of primary questions corresponding to that writing type; receiving answers to one or more of the primary questions; generating a plurality of secondary questions; receiving answers to the secondary questions; arranging answers to the primary and secondary questions as a function of the writing type; and generating (in some aspects, automatically) a writing using the answers to the primary and secondary questions. In addition, the invention in other aspects includes: receiving revisions to the first writing; and generating (in some aspects, automatically) a revised writing which incorporates said revisions. The method and/or system may produce, in certain aspects, a review, report, analysis, argument, essay, composition, comparison, narration, description, exposition, classification, definition, illustration, process, biography, term paper, thesis or dissertation. In one aspect, the primary question set comprises a request for a hypothesis. In another, the method generates a key sentence corresponding to each of the answers to the primary questions. In other aspects, the invention provides or generates advice or suggestion corresponding to the primary questions or secondary questions. The suggestion or advice may comprise a multiple choice suggestion, a writing sample, a template or a glossary, for example. Other aspects of the invention include: providing a display; and displaying a preview of the writing after receiving answers to some or all of the primary questions and/or secondary questions. In one aspect, an answer to the last of the primary questions is an introduction of the writing. Other aspects include: determining or selecting a time period to complete said writing; determining the time remaining in the time period; and displaying the time remaining in the time period; determining or selecting a length for the writing, wherein primary and/or secondary questions and/or key sentences are generated as a function of the desired length; generating a plurality of tertiary questions corresponding to the answers to said secondary questions; receiving answers to the tertiary questions; and arranging answers to the primary, secondary and tertiary questions as a function of the writing type. Another aspect of the invention includes maintaining a database of (or otherwise making available in electronic form) primary questions and/or secondary questions associated with or corresponding to the various types and styles of writing contemplated hereunder. The invention also includes a computer-readable medium having computer-executable instructions for performing the foregoing method and/or method steps, a computer-assisted method of performing same and/or a software package, computerized system and/or web-based system for performing same. As used herein, computer-readable medium includes any kind of computer or electronic memory, storage or software including without limitation floppy discs, CD-ROMs, DVDs, hard disks, flash ROM, nonvolatile ROM, SD memory, RAIDS, SANs, LANs etc. as well as internet servers and any means of storing or implementing software or computer instructions for use in connection with managing a website and/or managing user sessions over the internet and/or enabling interactive web-based communications and/or enabling interactive software products.

The general object of the invention is to provide an improved method and system for creating a writing. Another object is to provide an interactive (such as a software, internet and/or computer-based) method for creating a writing. The invention described herein is superior and distinguished from the prior art because, among other things, it offers in various aspects the following objects and advantages: The invention results in organized, developed, unified compositions efficiently; promotes logical, hierarchical progression of ideas; promotes thoroughness with little or no vital facets overlooked; promotes originality as well as integrity; coordinates proportion of coverage with time and length requirements; provides guidance, suggestions, and reminders of correctness (e.g., grammar, syntax, punctuation) and proper documentation of sources; encourages creativity as well as self-control of ideas; breaks down writer's block and offers time-management of tasks; allows methodical creation of introductions, conclusions, documentation; guards against unsupported ideas and poorly illustrated examples; alerts users on how to avoid troublesome pitfalls; suggests alternative and transitional expressions and vocabulary suited to style and type, thus discouraging blandness, disunity, and generalizations; allows writing to be an orderly yet relaxed expression of ideas rather than a matter of highly serious tension; and/or offers an honest alternative to plagiarism.

These and other objects and advantages will become apparent from the foregoing and ongoing written specification, the accompanying drawings and the appended claims.

### BRIEF DESCRIPTION OF THE DRAWINGS

FIG. 1 is an illustration of questions posed to a user of one embodiment of the invention with determinants of a type or style of writing.

FIG. 2 is a table for converting a writing project's required length into number of words.

FIG. 3 is a table determining the number of primary questions and secondary question sets in an example of the present invention.

FIG. 4 is an interactive screen of one embodiment of the present invention illustrating a first primary question together with advice, help and model answer options.

FIG. 5 is an illustration of an interactive screen with primary questions and answers in one embodiment of the invention.

FIG. 6 is an example “preview” screen.

FIG. 7 is an example interactive screen of one embodiment of the present invention showing secondary questions and answers.

FIG. 8 is an example “preview” screen incorporating answers to example secondary questions.

FIG. 9 is a further example of an interactive screen showing secondary questions associated with a different primary question.

FIG. 10 is another example “preview” screen incorporating answers to other secondary questions.

FIG. 11 is a further example of an interactive screen showing secondary questions associated with a different primary question.

FIG. 12 is another example “preview” screen incorporating answers to other secondary questions.

FIG. 13 is a further example of an interactive screen showing secondary questions associated with a different primary question.

FIG. 14 is another example “preview” screen incorporating answers to other secondary questions.

FIG. 15 is a further example of an interactive screen showing secondary questions associated with a different primary question.

FIG. 16 is another example “preview” screen incorporating answers to other secondary questions.

FIG. 17 is a further example of an interactive screen showing secondary questions associated with a different primary question.

FIG. 18 is another example “preview” screen incorporating answers to other secondary questions, with references.

FIG. 19 is a further example of an interactive screen showing secondary questions associated with a different primary question.

FIG. 20 is another example “preview” screen incorporating answers to other secondary questions, with references.

FIG. 21 is an example interactive screen which permits a user of one embodiment of the invention to make edits to a writing.

FIG. 22 is another example interactive screen which permits a user of one embodiment of the invention to make edits to a writing.

FIG. 23 is an example of a publication-ready writing generated by the present invention.

FIG. 24 is an example interactive screen of one embodiment of the present invention.

FIG. 25 is an example interactive screen for creation of a bibliography.

FIG. 26 illustrates examples of title pages and references which may be generated in one embodiment of the present invention.

FIG. 27 is flow chart illustrating one embodiment of the present invention.

### DESCRIPTION OF THE PREFERRED EMBODIMENTS

At the outset, it should be clearly understood that like reference numerals are intended to identify the same elements, parts and portions consistently throughout the several drawing figures, as such elements, parts and portions may be further described or explained by the entire written specification, of which this detailed description is an integral part. Unless otherwise indicated, the drawings are intended to be read together with the specification, and are to be considered a portion of the entire written description of this invention.

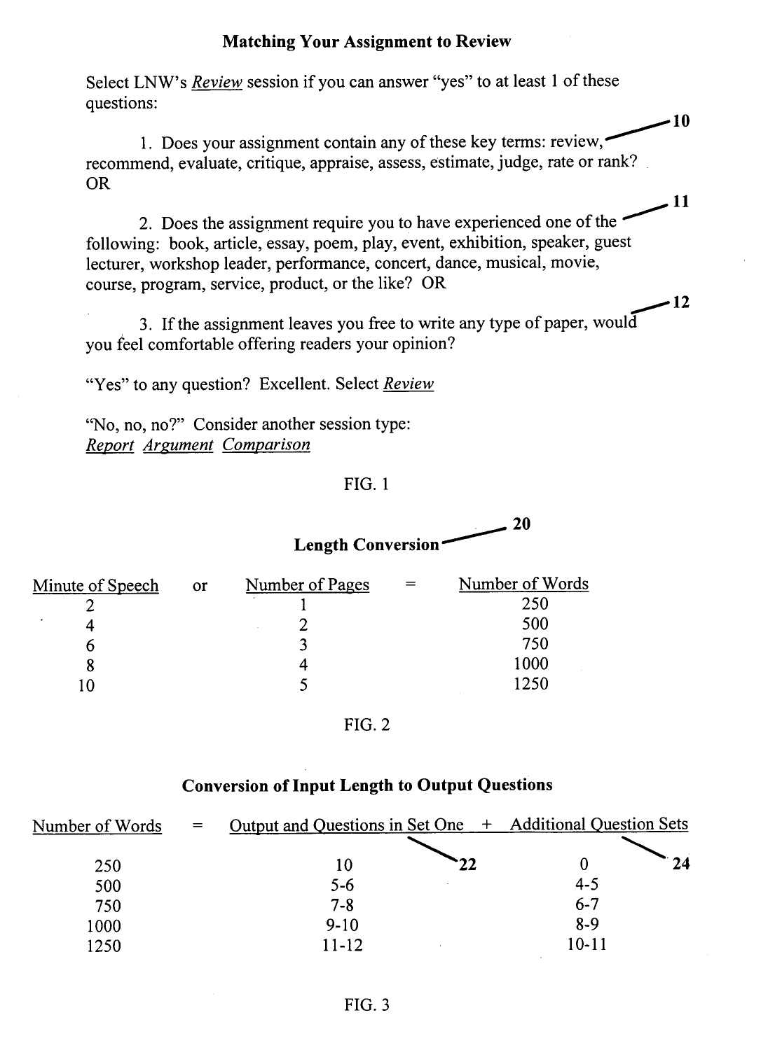

One embodiment of the system in its interactive form outputs determinants of basic through advanced writing types, ranging from informative (such as a report) to interpretive (such as an analysis) to persuasive (such as an argument) while categorizing styles into personal, academic, and professional. FIG. 1 illustrates the determinants 10, 11, 12 a would-be user may consider in selecting a type and/or style of writing—in this illustration, a review. In this embodiment, the user either selects a “review” as the desired writing style/type, or opts to see the determinants of other types and styles before selecting a suitable match, which is then inputted, or may exit the system. In a preferred embodiment, a table or set of questions with information similar to that set forth in FIG. 1 is displayed on a computer monitor as a web page in a web-based system or as a screen in a software-based system for creating a writing.

FIG. 2 shows an example of a table 20 for conversion of inputted user information in terms of optimal form/format (written or spoken) and length (words or minutes) into standardized word units (in this example, 1 unit=any combination of six characters/spaces; 250 words=1 double-spaced page; 125 words=1-minute speech). For example, consider a student needing to create an 8-10 minute persuasive speech, or a sales representative needing to create a 2-page competitor-product assessment: the output in the first case would be 1,000-1,250 spoken words while in the second case, the output would be 500 written words.

FIG. 3 is an example of a table showing the number of questions a user will need to complete the type/style/length inputted previously, divided into two categories—primary questions 22 (as described below) for communicating main ideas, and secondary question sets 24 (as described below) for developing support. In this example, the table for determination would yield in the student example above 9-12 primary questions and 8-11 secondary question sets and, in the sales representative example, 5-6 primary questions and 4-5 secondary-question sets.

In addition to the web and/or software-based system of the preferred embodiment, a manual method or system of the present invention may employ tables, charts, or formulae; input may be done manually (e.g., in an office or classroom; and/or in a user's own text editor, word processing software or system) or alone by form with chart and tables, digitally, electronically, over the Internet, via email (by attachments) or web service, in which case an online user in Hong Kong could transmit personal information into a server in Canton, Ga., for example.

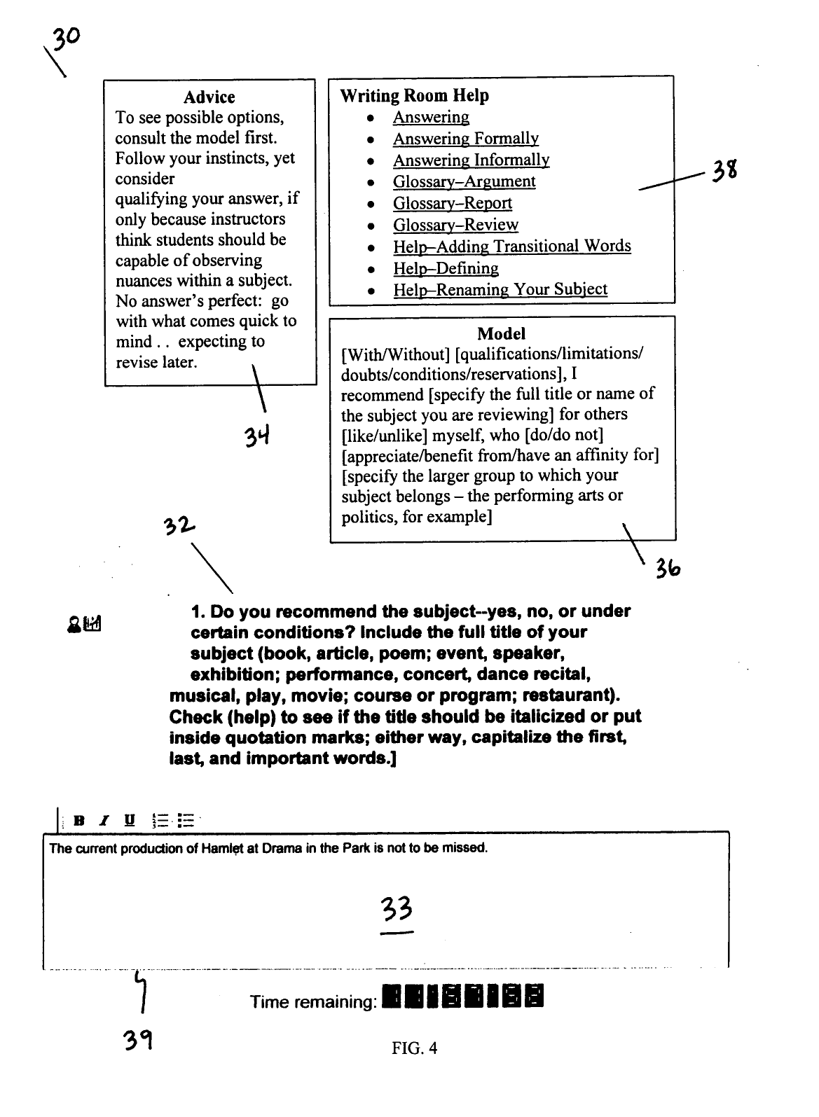

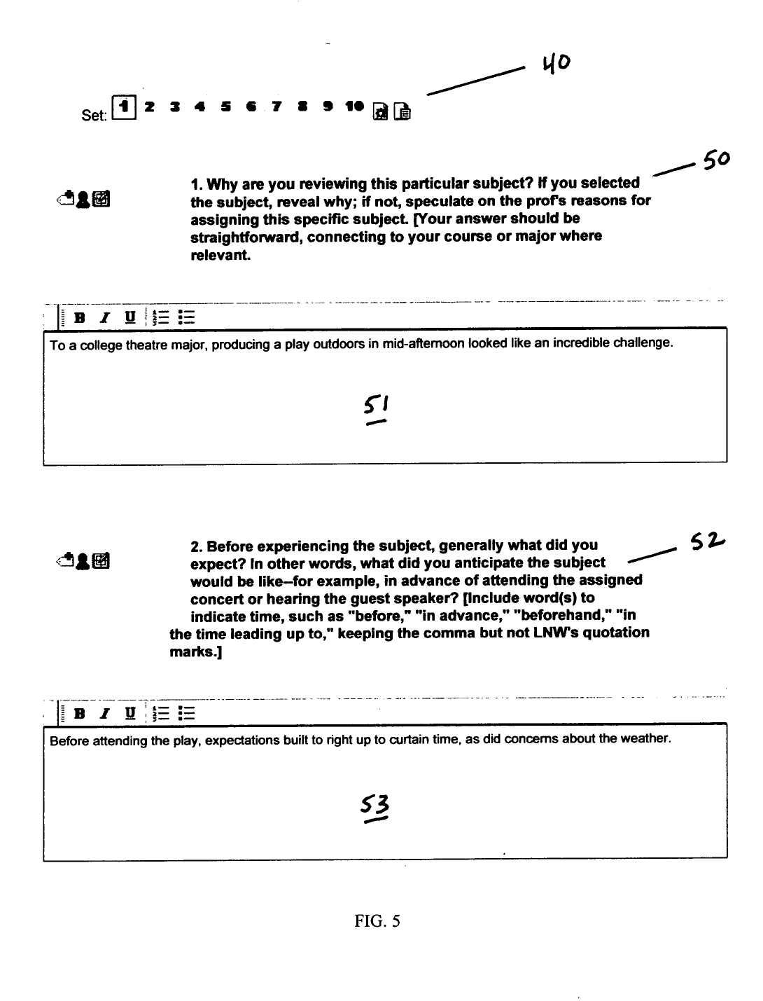

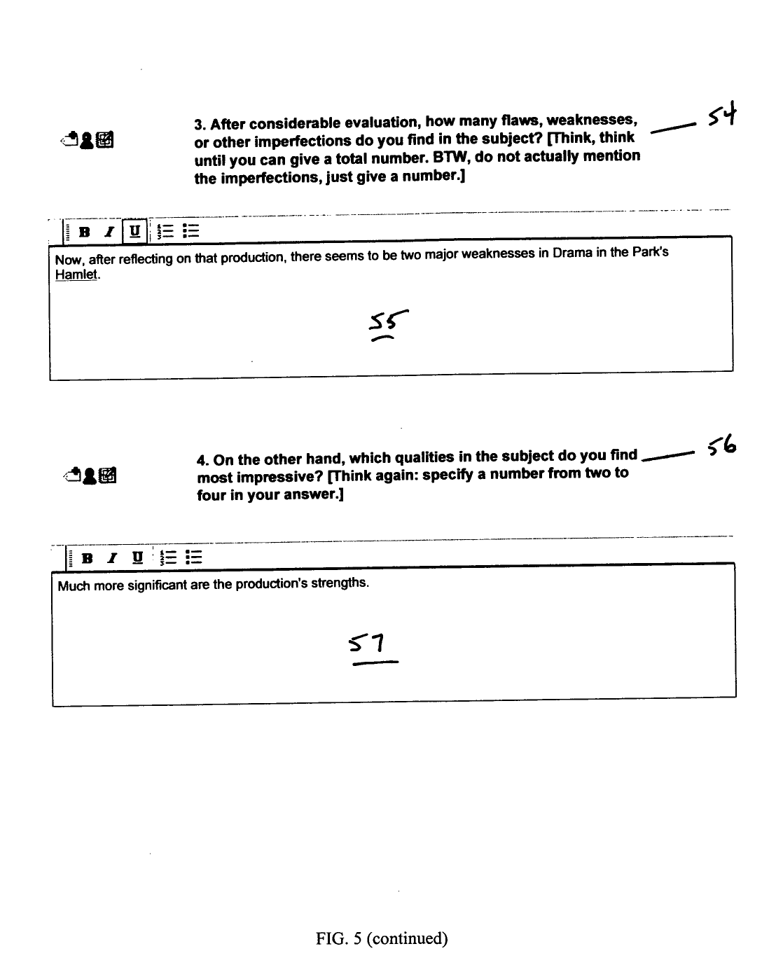

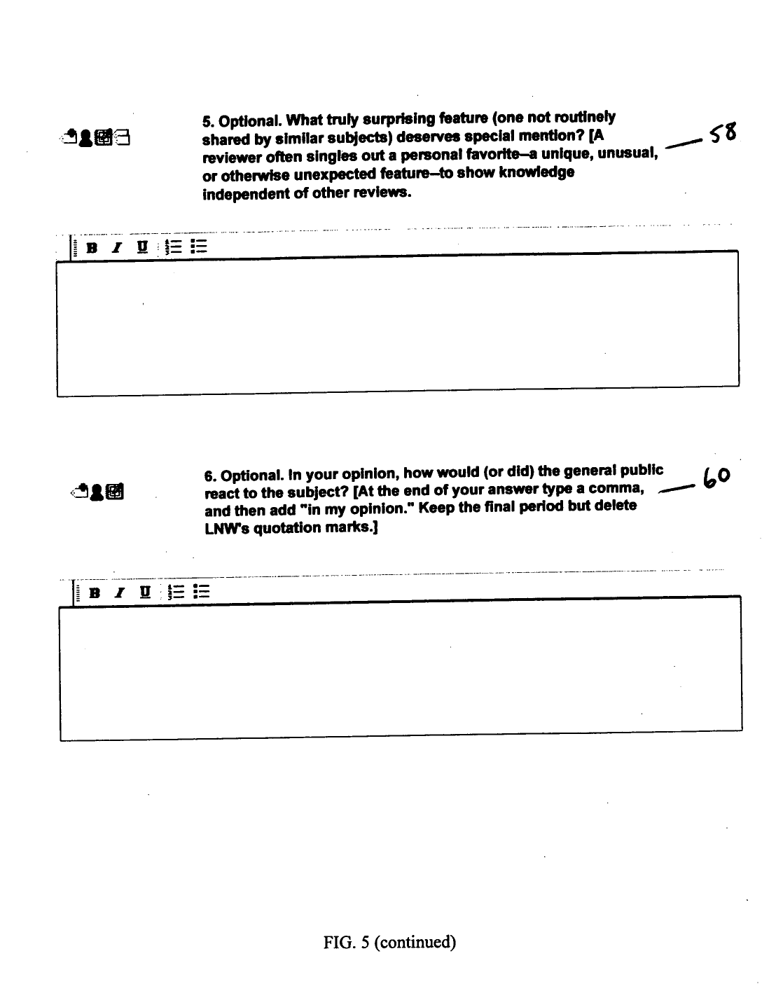

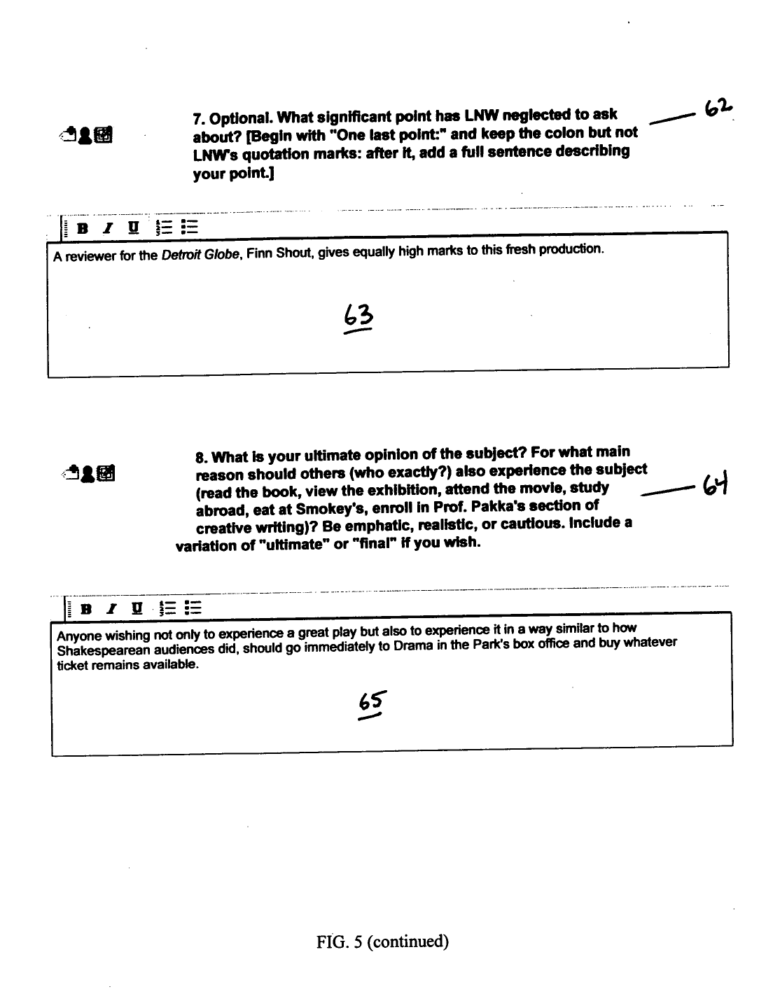

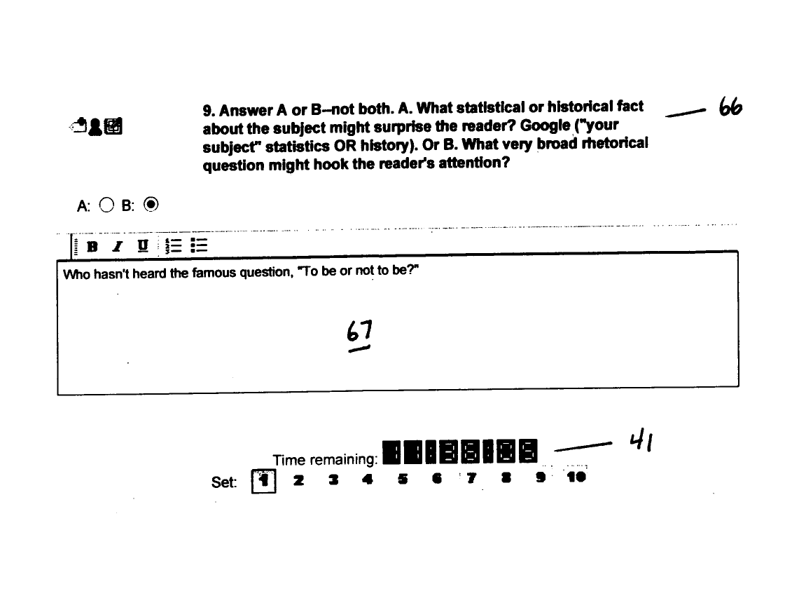

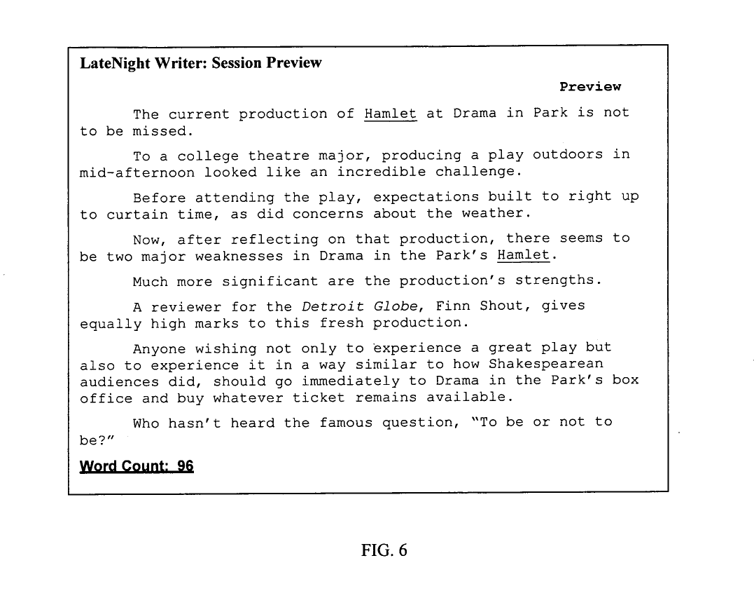

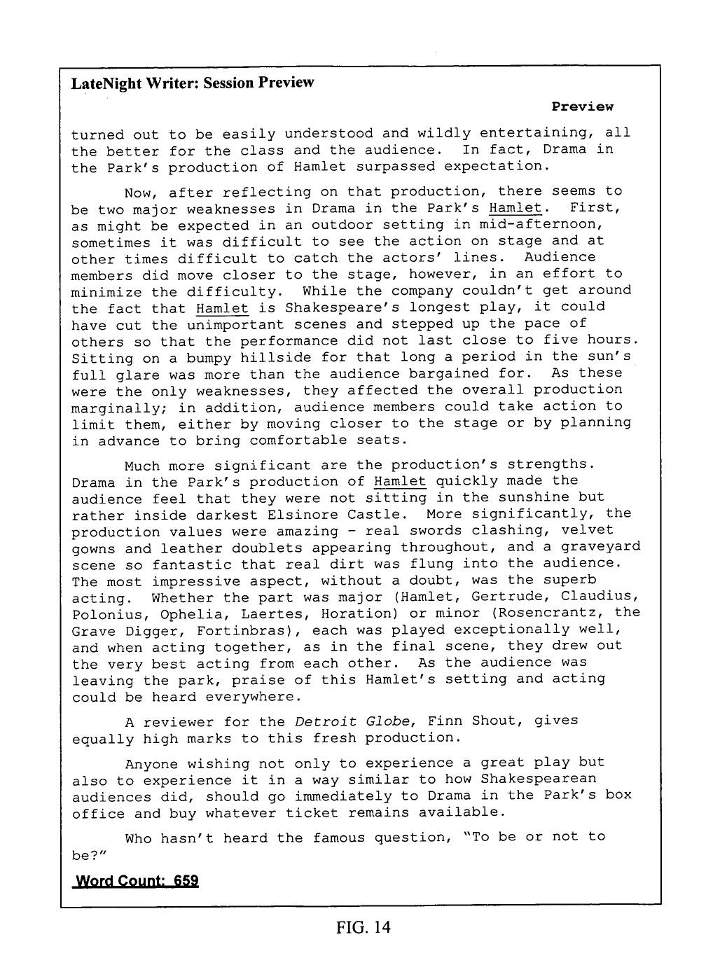

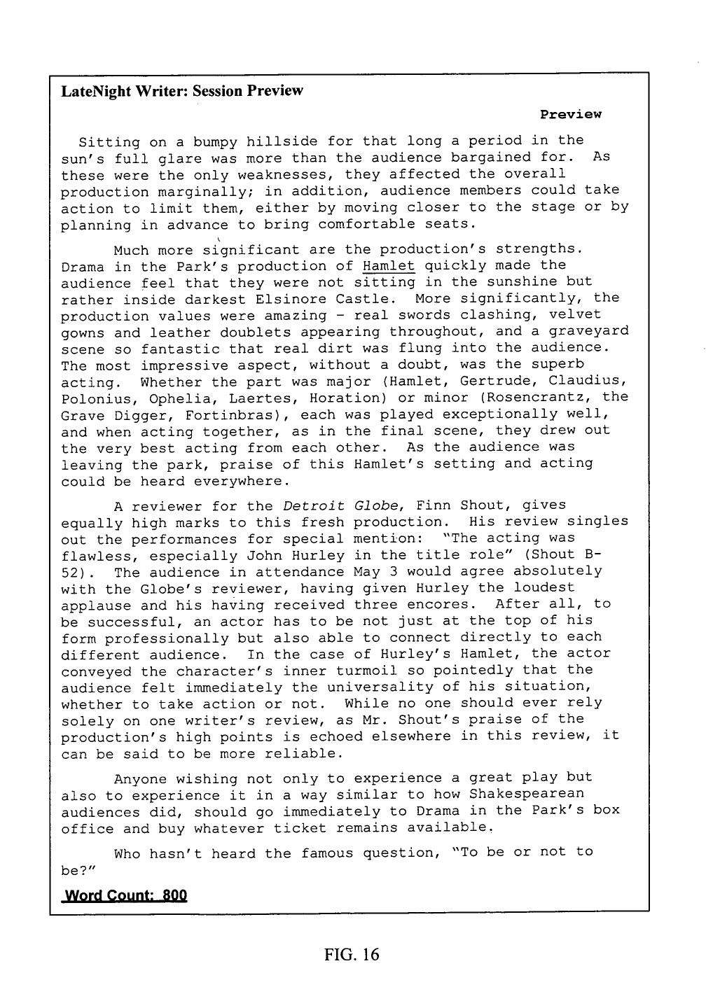

FIGS. 4-22 and 24-26 show interactive screens in a web and/or software-based embodiment of the present invention. FIG. 4 shows a first interactive screen 30 (for a 1250-word academic composition or 10-minute speech, without the inclusion of primary or secondary sources, in this example). The system displays an initial primary question 32 which must be answered 33 which stands as the writing's hypothesis. In this embodiment, the user may consult advice 34; generic multiple-choice or model suggestions 36 for answering if stuck for appropriate words; a type/style sample (thorough an on-screen link, icon, button or tab, for example); help 38; and/or a glossary of associated type/style terms (thorough an on-screen icon, link, button or tab, for example). Any of the items in the foregoing sentence may be referred to herein individually or collectively as “advice,” as well as any other information which might be supplied to a user to create an improved writing. The user enters at least a one-sentence answer into a box 39 and submits the answer by selecting a button, for example. In this embodiment, the entered hypothesis will be displayed or a computer monitor isolated initially as a “preview” or in a “preview box” (see, FIG. 6) until the user completes the final set's last question, the answer to which forms the writing's ultimate thesis, at which time the hypothesis is deleted. In this example, the user begins by expressing an hypothesis appropriate to the writing's type and style, and finishes with a refined thesis, much like a logical proof. Optionally, this embodiment includes indicators of time left to complete a question set and to complete the writing, which can keep a writer on track to finish by a predetermined time (in this example, 12 hours), and can provide a personal performance gauge. Example time indicators 41 as used in the interactive web and/or software-based screens of this embodiment are illustrated in FIGS. 5, 7, 9, 13, 15, 17, 19 and 24. Also, a grid 40 (such as that shown in FIGS. 5, 7, 9, 11, 13, 15, 17 and 19) may display set and question numbers.

FIG. 5 shows a sequence of interactive screens and boxes, each with a primary question 50, 52, 54, 56, 58, 60, 62, 64, 66 that, if answered 51, 53, 55, 57, 63, 65, 67 fully, can create a key sentence. In this embodiment, each question answered will later trigger a corresponding set (or sets) of secondary questions (as described herein). The user creates a key sentence 51 for what will become the second paragraph of the writing (in this embodiment, a review)—that is, the first fully developed paragraph after the introduction. The user hereby creates another key sentence 53 by answering a second primary question 52. Following or discounting the direction for style, the user completes another key sentence 55 by responding to another primary question 54, conforming to paragraphing norms—e.g., description, narration, definition, classification, persuasion, comparison/contrast, cause-and-effect, illustration, etc. The user creates another key sentence 57 by responding to the fourth primary question in this example 56, this time following or discounting another style suggestion. This embodiment also provides for fifth 58, sixth 60 and seventh 62 primary questions; however, in this example, these questions are optional, depending on the user's personal requirements of length and style, and includes suggestions for adding a transitional word or phrase in the answer. A secondary consideration is that perhaps a user not needing this one to reach length or conform to style will answer anyway, opting for maximum possible output. In this embodiment, questions not labeled “optional” are to be completed in accordance with the user's personal requirements of style or length or both. Additional primary questions 64, 66 are also illustrated in this embodiment.

Question “9” in this review example devises the first sentence of the introduction; more specifically, depending on personal information regarding style, a user may answer the more formal “A” or less formal “B” question 66, 67. While this is the last primary question asked of the user in the first questionnaire set, the answer, which is also required in this example, will ultimately appear as the first sentence of the introduction of the writing. Many writers fidget so about introductions that they too often work themselves into a tizzy that reduces their wits to such mush that they cannot get on with a draft of a writing, or their overtaxed brains empty ideas helter-skelter into an introduction, thereby creating lengthy incoherence that establishes from the writing's onset that the writer is not thinking straight. By placing this primary question 66 last, the method and system described in this embodiment can contain anxiety at minimal levels.

FIG. 5 shows a sequence of interactive screens in this embodiment, which are also intended to create key sentences in the writing (and, if so, to trigger a corresponding set of secondary questions later). A user, after reading an explanation of the type/style's requirement, may answer or skip primary questions 58, 60, 62 depending on personal requirements of length or style, or both, or whether the user wants to maximize output, regardless of such requirements. If the user answers primary question 60, for example, then a corresponding secondary question set will be later outputted; if the user skips this optional question, then the secondary set will not be outputted. Another primary question, which is not illustrated, may ask a user to rank the subject matter of the review in comparison to similar works or similar subject matter. Another primary question may be added to the method or system which is not merely another optional question that the user may or may not answer according to personal requirements and preferences; instead, it can be elected by the user needing the writing to include special or additional topical matter not addressed by the previous primary questions (for example, the following primary question might be included: “What significant point has the system neglected to ask you? Begin with ‘One last point, . . . ’ and add a sentence to describe your point.”). Of course, the order and/or sequence of the questions in this preferred embodiment is not a limitation of this invention. The order and sequence (and the inclusion or exclusion of specific questions) may be varied in various embodiments of the invention. Similarly, primary (and secondary) questions for writing types/styles other than the “review” in this example may vary widely.

FIG. 5 also illustrates a primary question 64 for creating the first sentence of the concluding paragraph of the writing. In this embodiment, the user must answer this question; otherwise, the writing would end with the corresponding set of the last key-sentence question answered. However, repeat users, for instance, may elect to skip answering this question 64, having a more stylized conclusion in mind. Optionally, a user may skip development questions, preferring instead to use the system just to compose artificial concluding and introductory paragraphs. Completing the primary questions 50, 52, 54, 56, 58, 60, 62, 64, 66 may be used to create an outline in another embodiment of the invention. For users with requirements of brevity (e.g., 2 minutes/250 words), such an outline may be used as a suitable

FIG. 6 is a “preview” page or screen which may be displayed at almost any point during the use of this embodiment (by selecting a link, button or tab, for example) after a user inputs answers to some or all of the primary questions. This FIG. 6 illustrates an example “preview” after only selected primary questions 32, 50, 52, 54 56, 62, 64 66 have been answered. At this stage, the “Preview” stands as a formal outline (e.g, one that could be printed and submitted when a professor or instructor requires such).

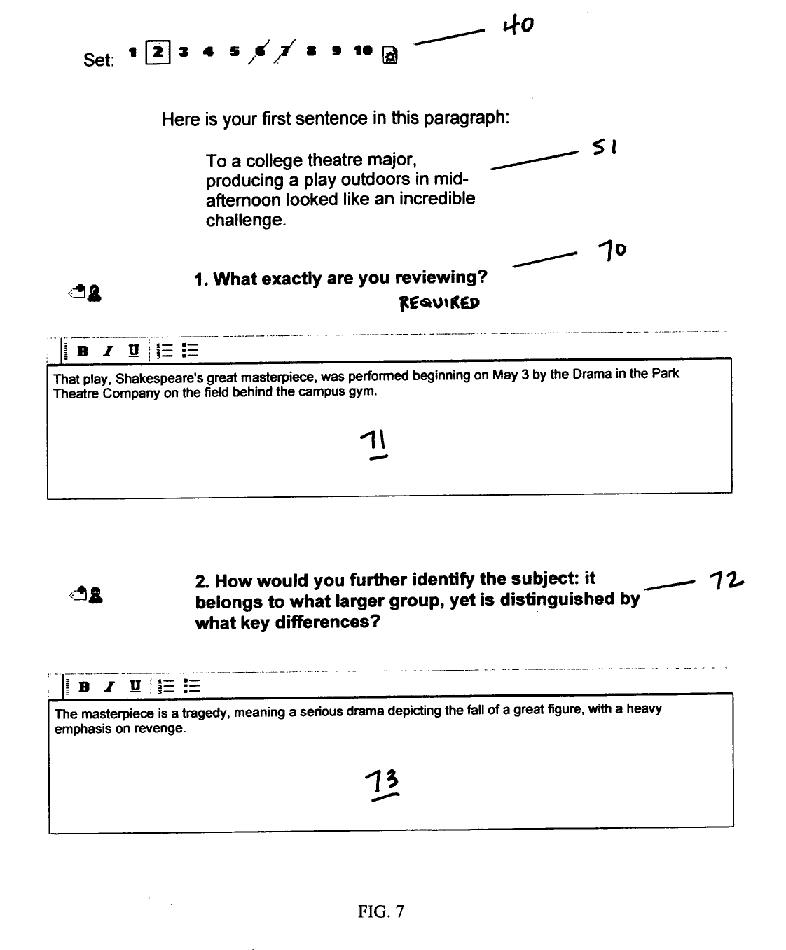

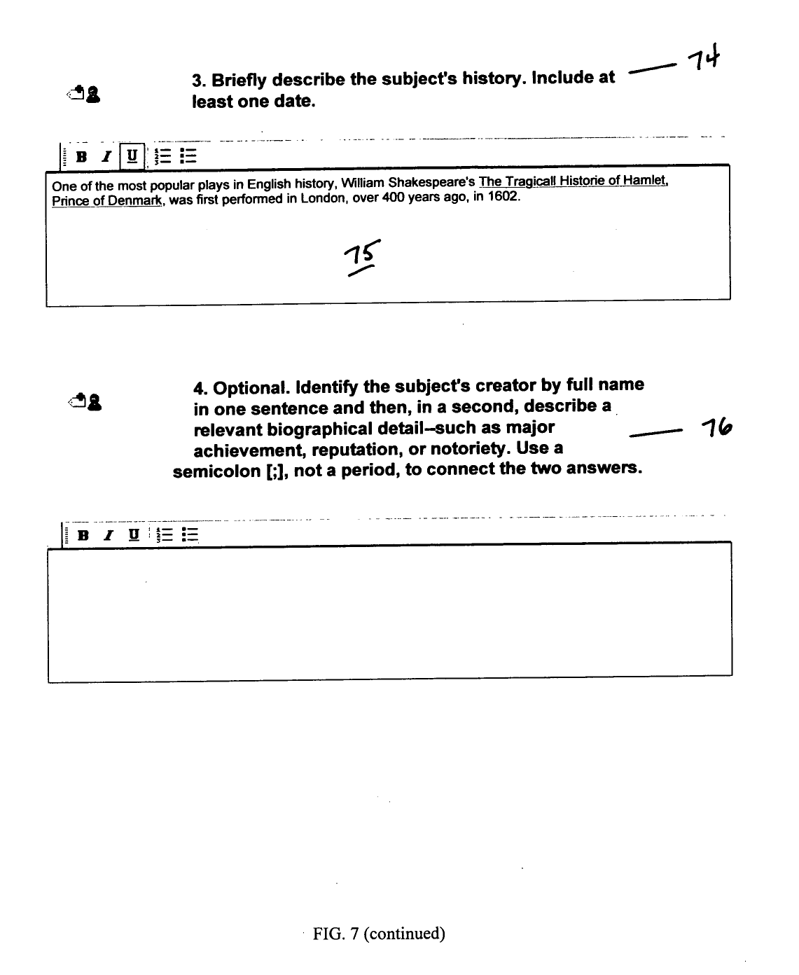

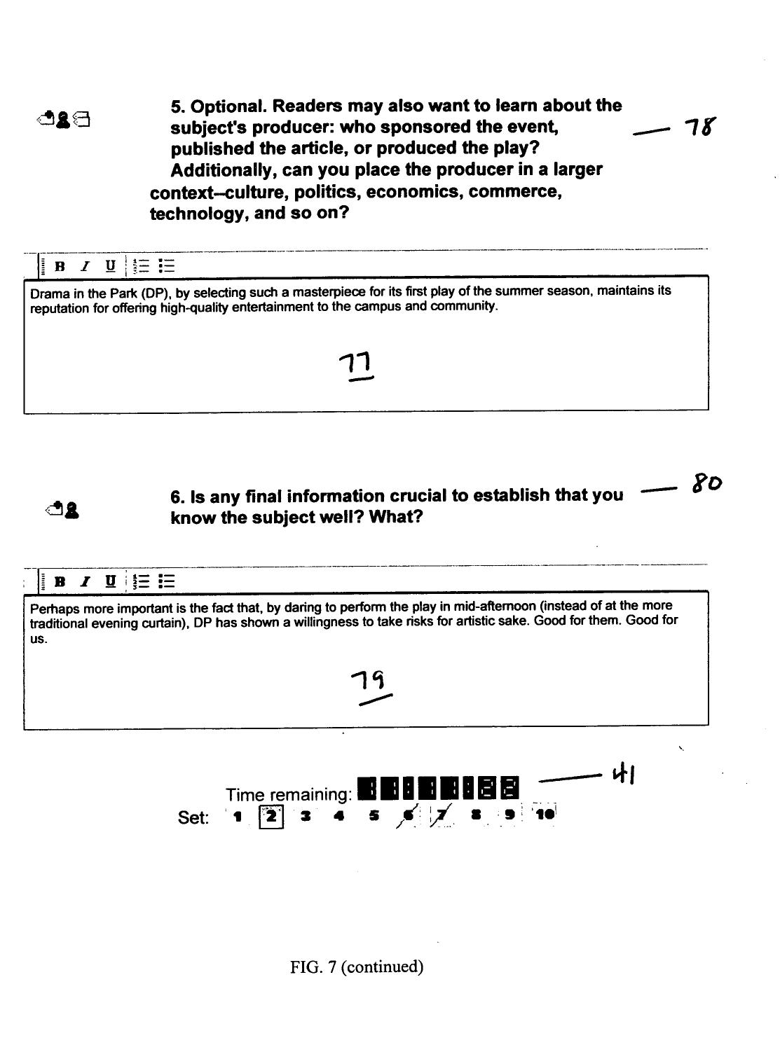

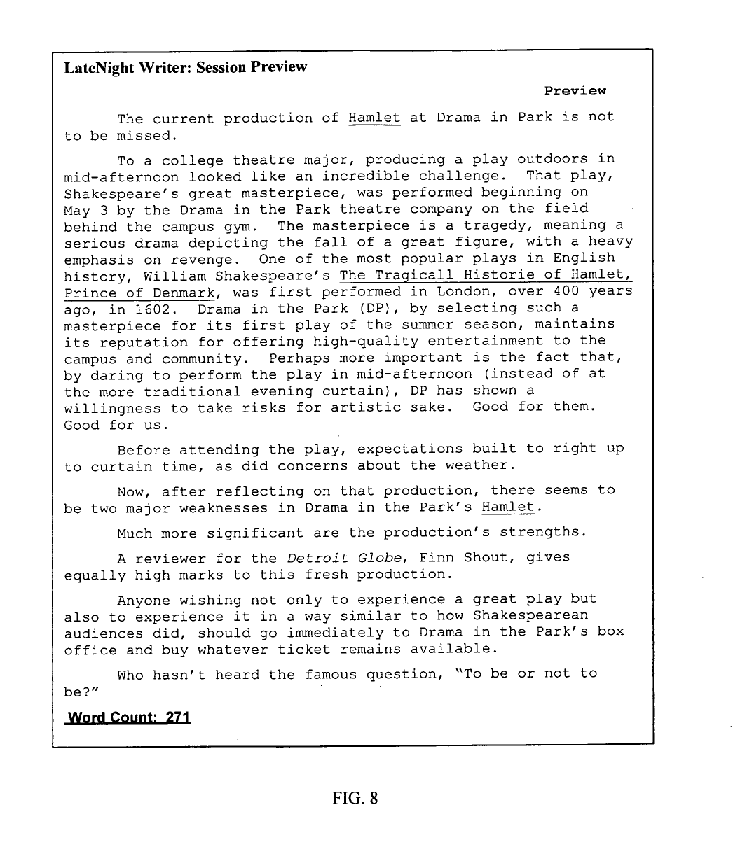

FIG. 7 illustrates a series of interactive screens and boxes with a set of secondary questions corresponding to the primary questions and the answers to the primary questions—in this case, question 50 from Set 1 (shown in FIG. 5). The user's answer 51 to that question is also displayed on this secondary question screen as a means of focusing the user's attention while considering a secondary question 70 and maintaining it while answering 71. The set of six secondary questions 70, 72, 74, 76, 78, 80 is in an orderly sequence for developing evidentiary sentences supportive of the corresponding key sentence 51 (resulting in form from corresponding primary questions) in paragraph form. As with the set of primary questions, secondary questions may be marked “required” (must be answered) 70, “optional” (may be answered) 76, 78 or unmarked (should be answered) 72, 74, 80. If the user doesn't answer a required secondary question, a message will appear to the effect that the question should be answered. FIG. 8 shows an updated “preview” screen available after the user responds to the secondary questions in FIG. 7. In this example, the second paragraph of the preview is expanded and the word count updated.

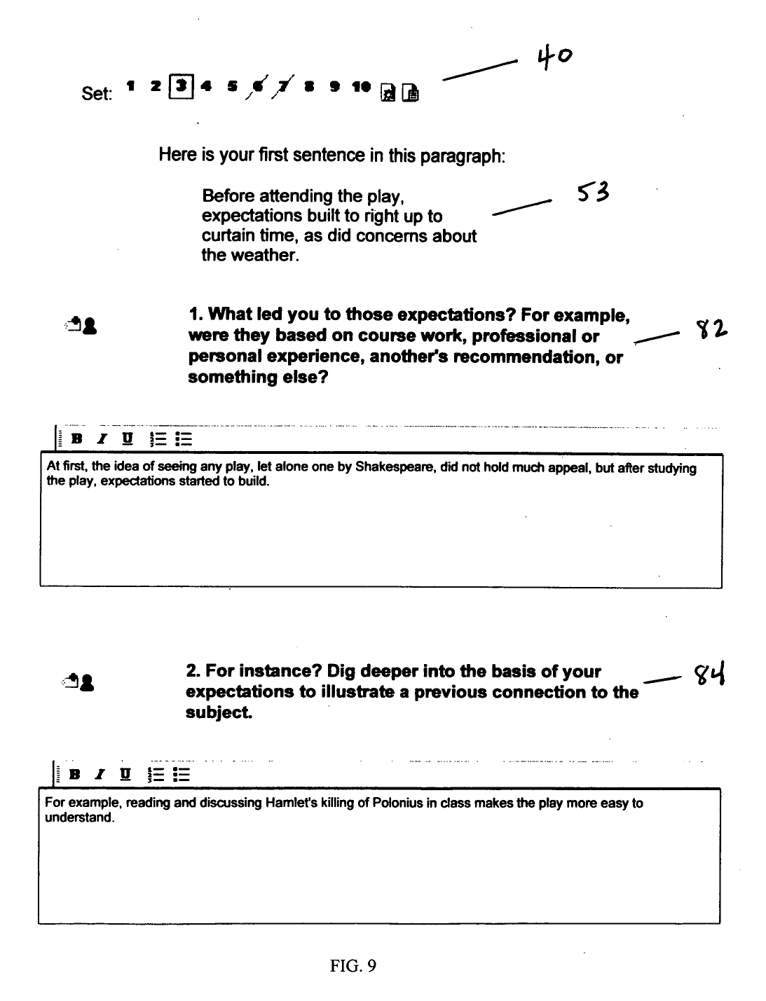

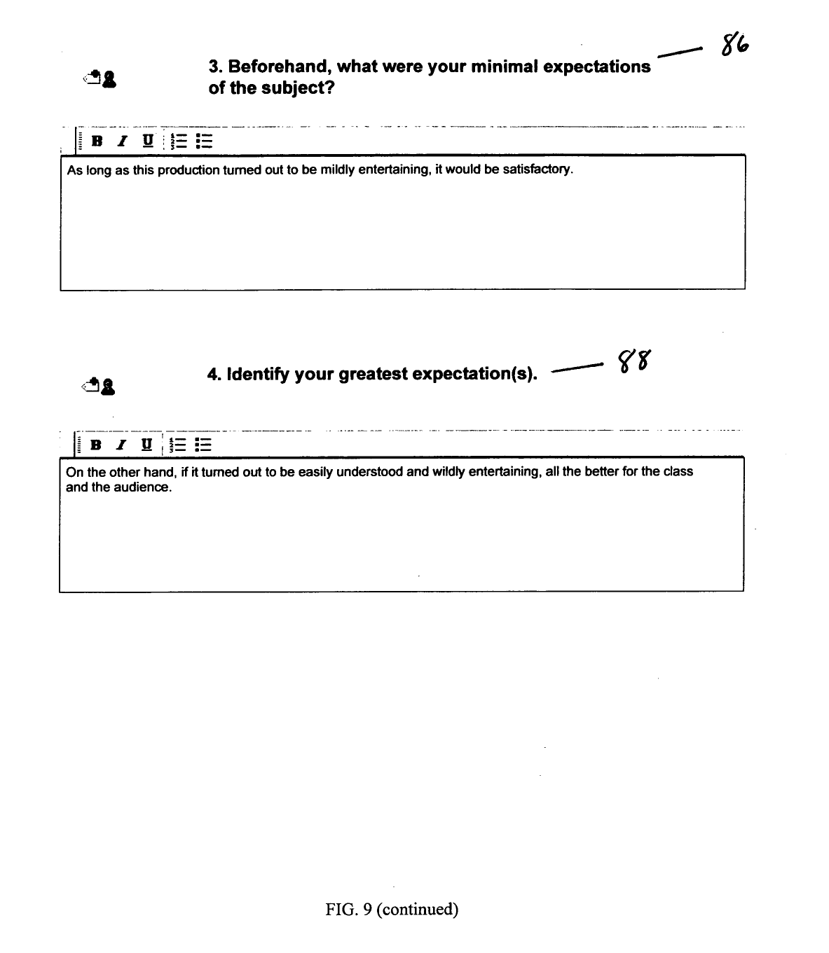

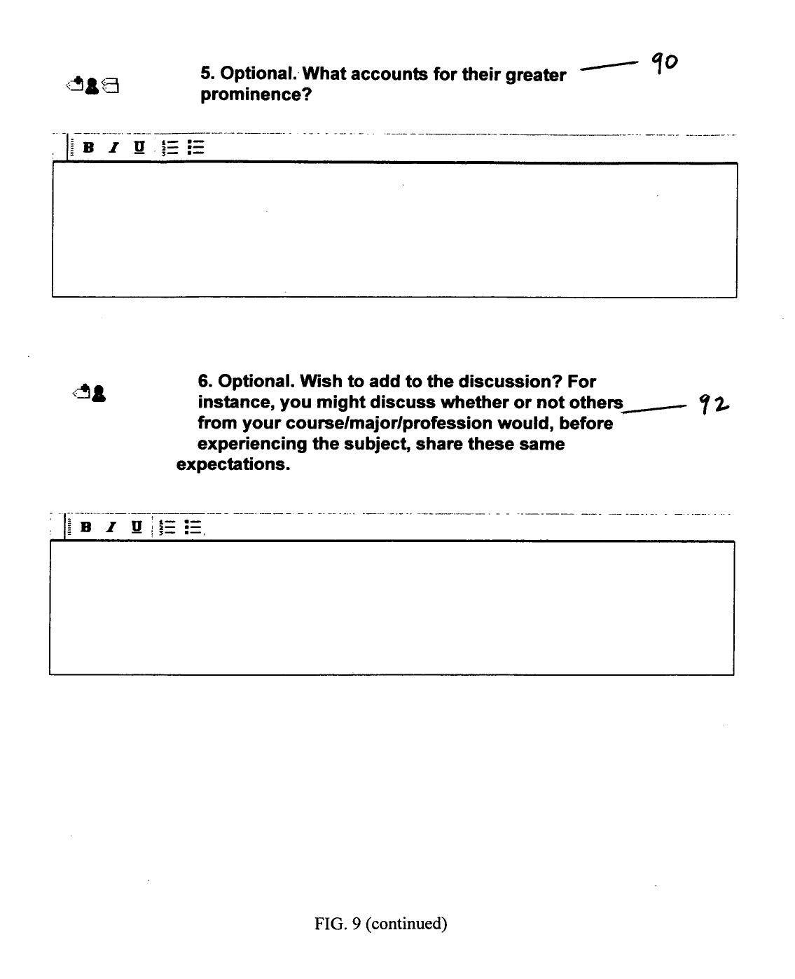

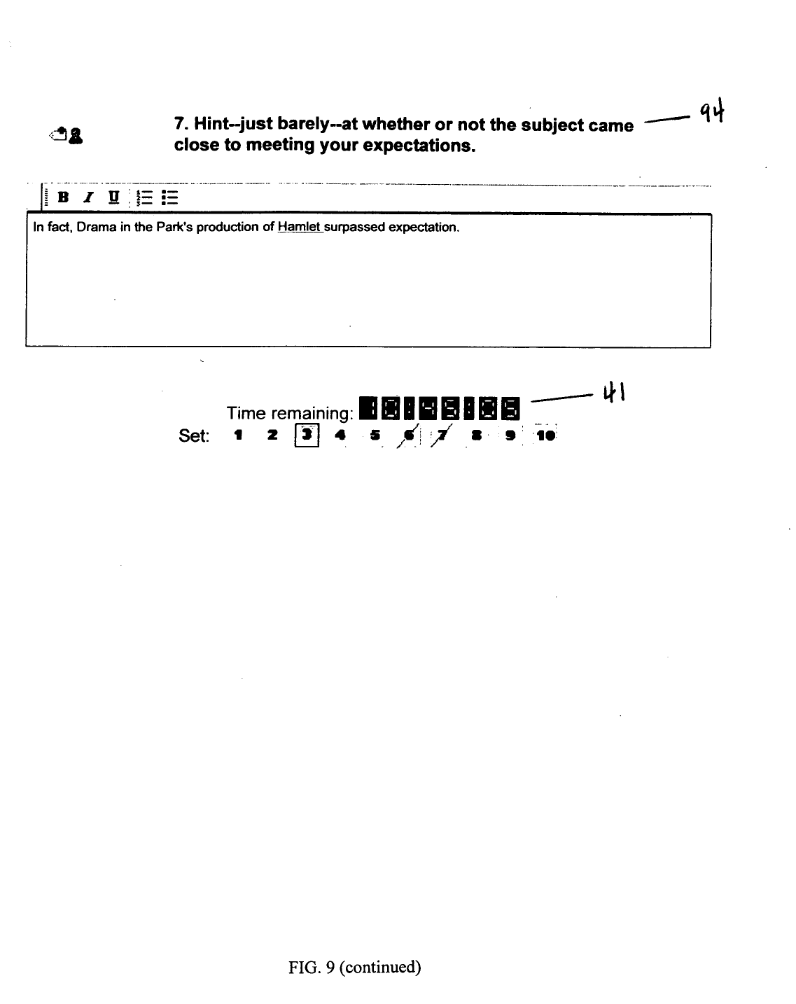

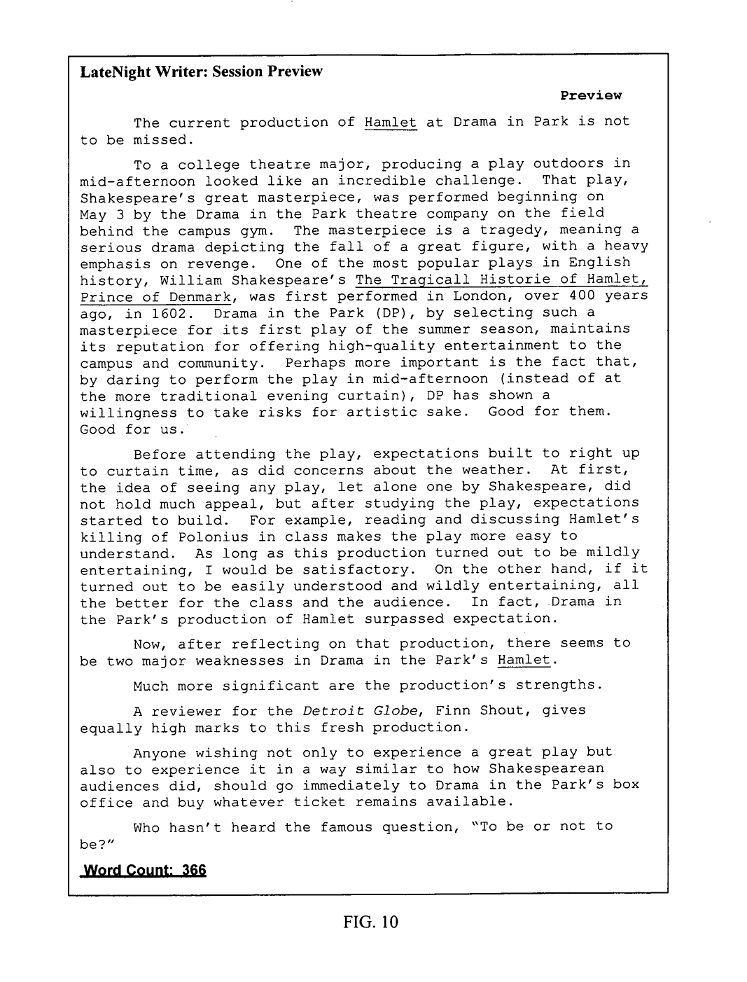

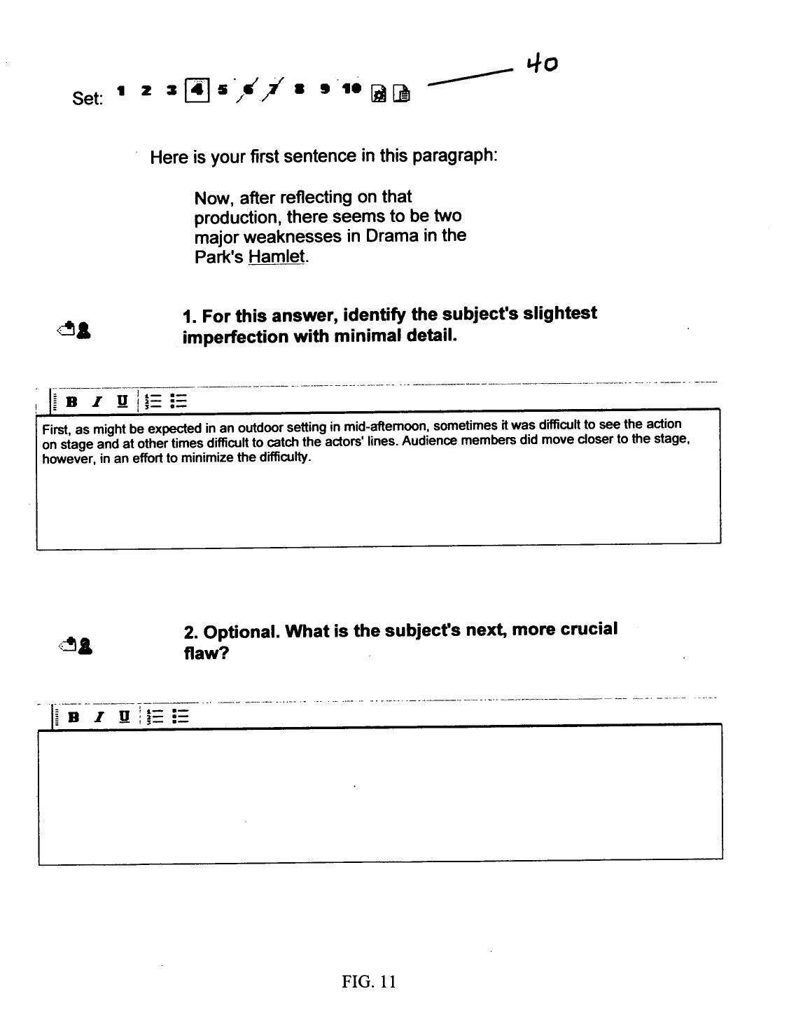

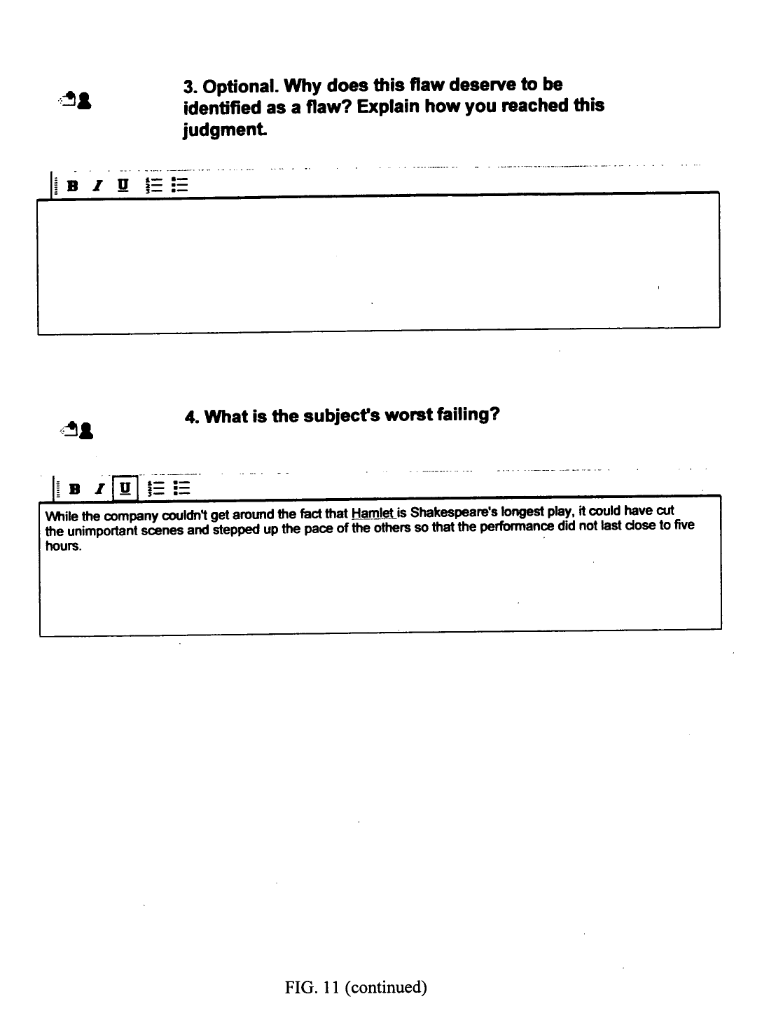

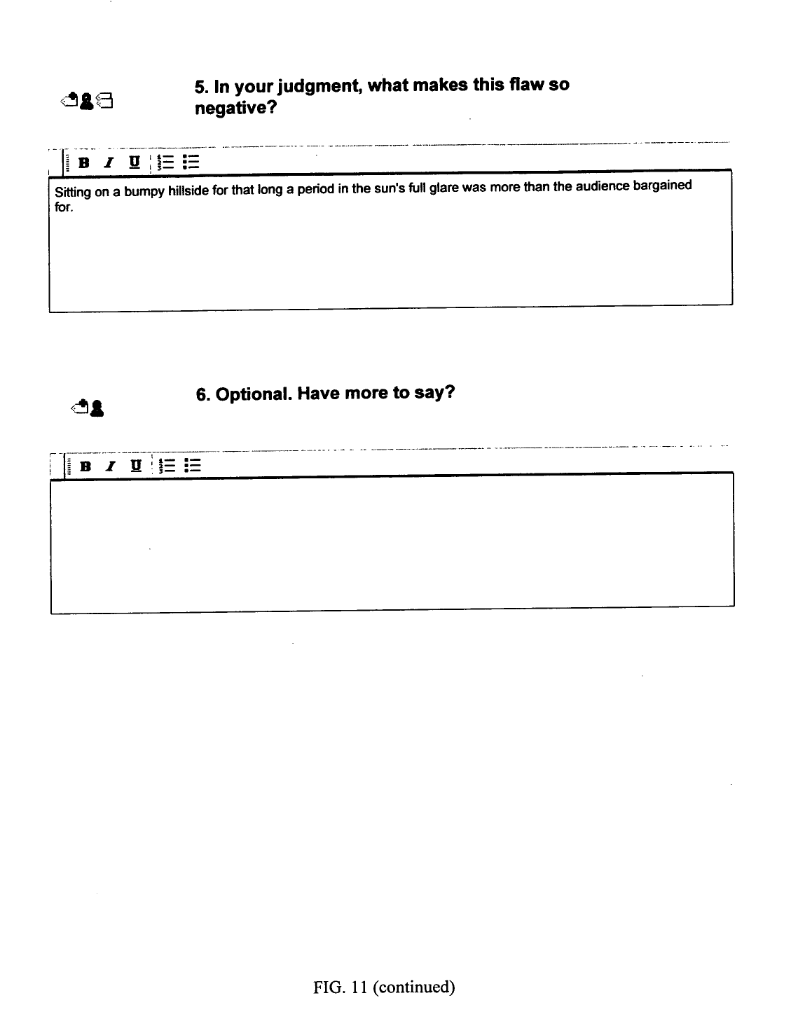

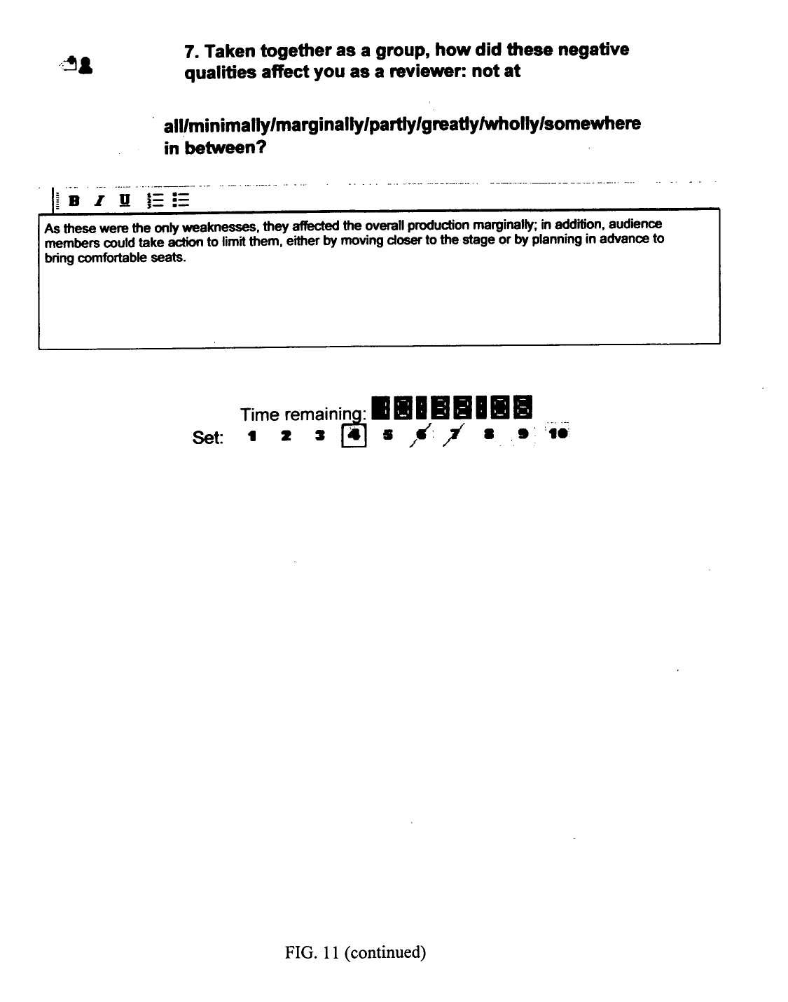

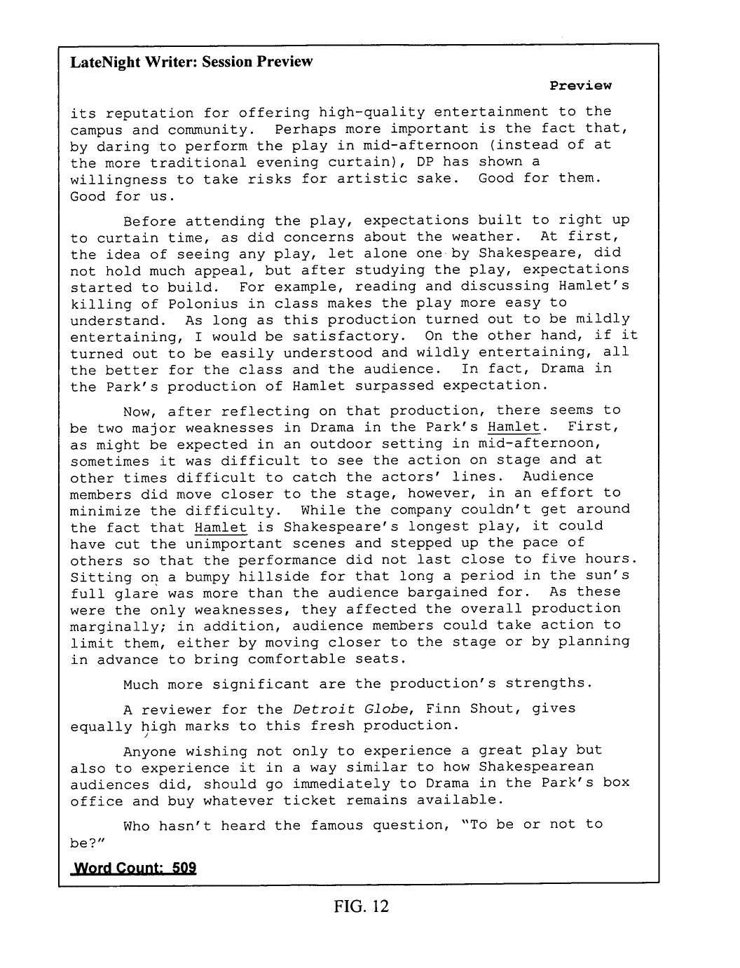

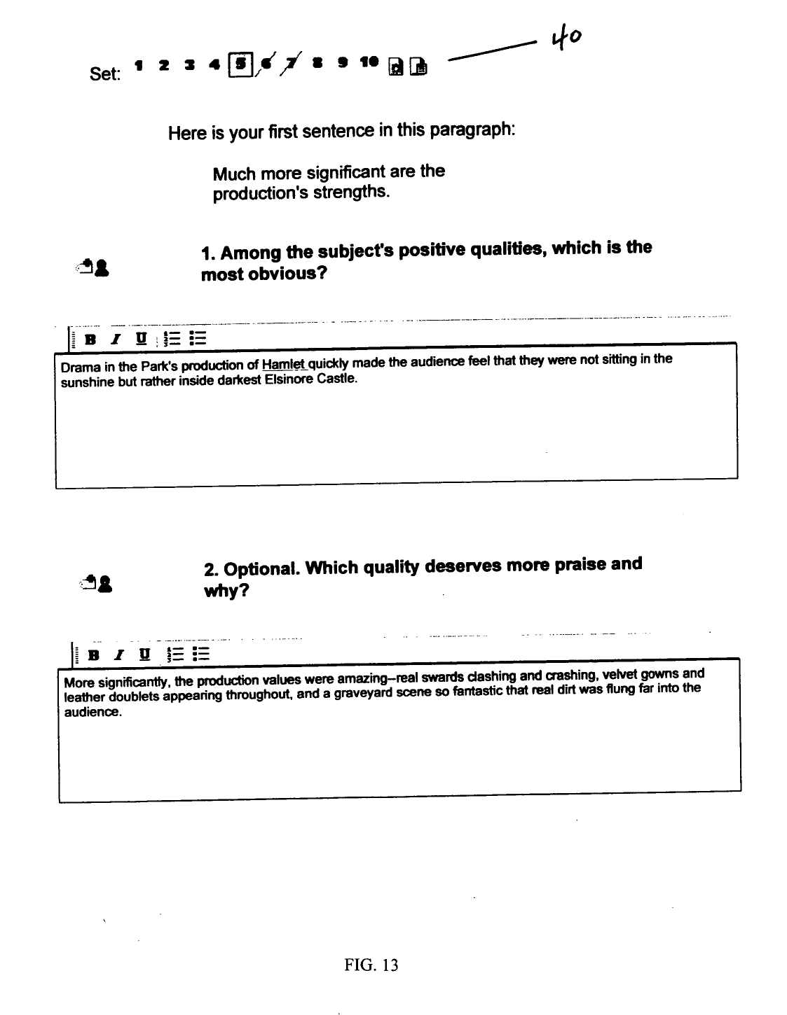

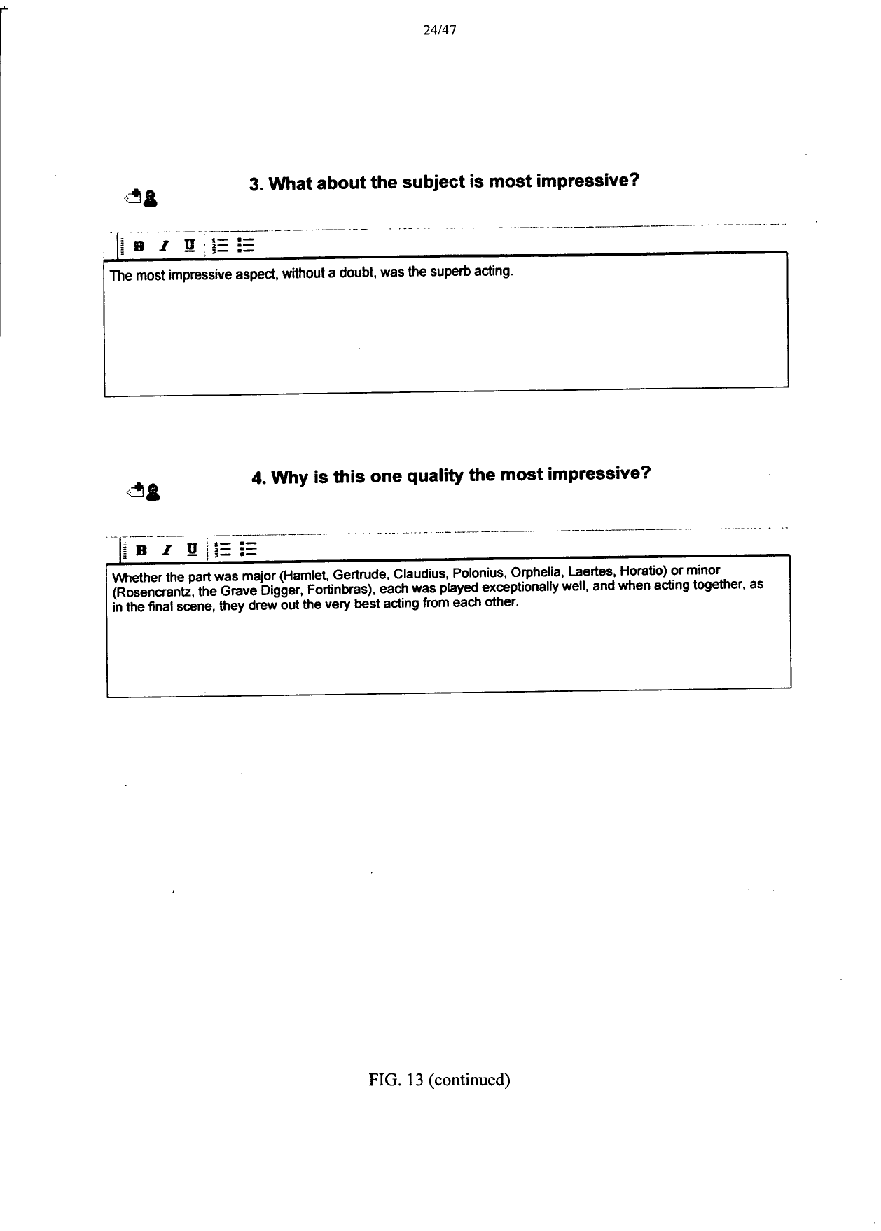

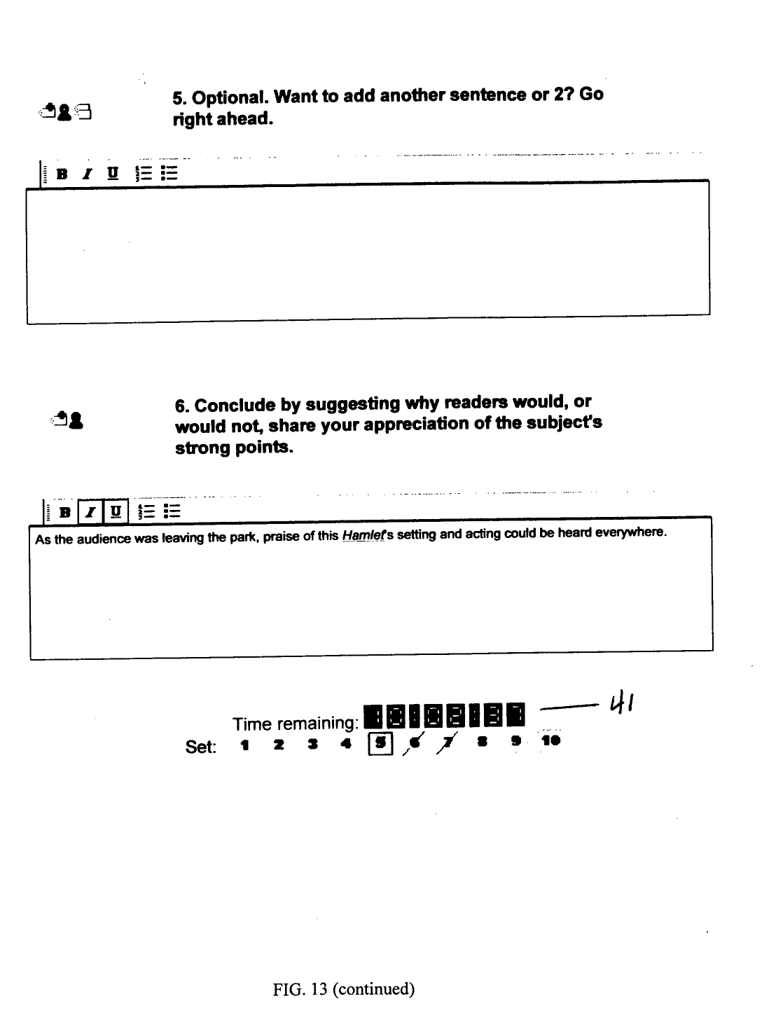

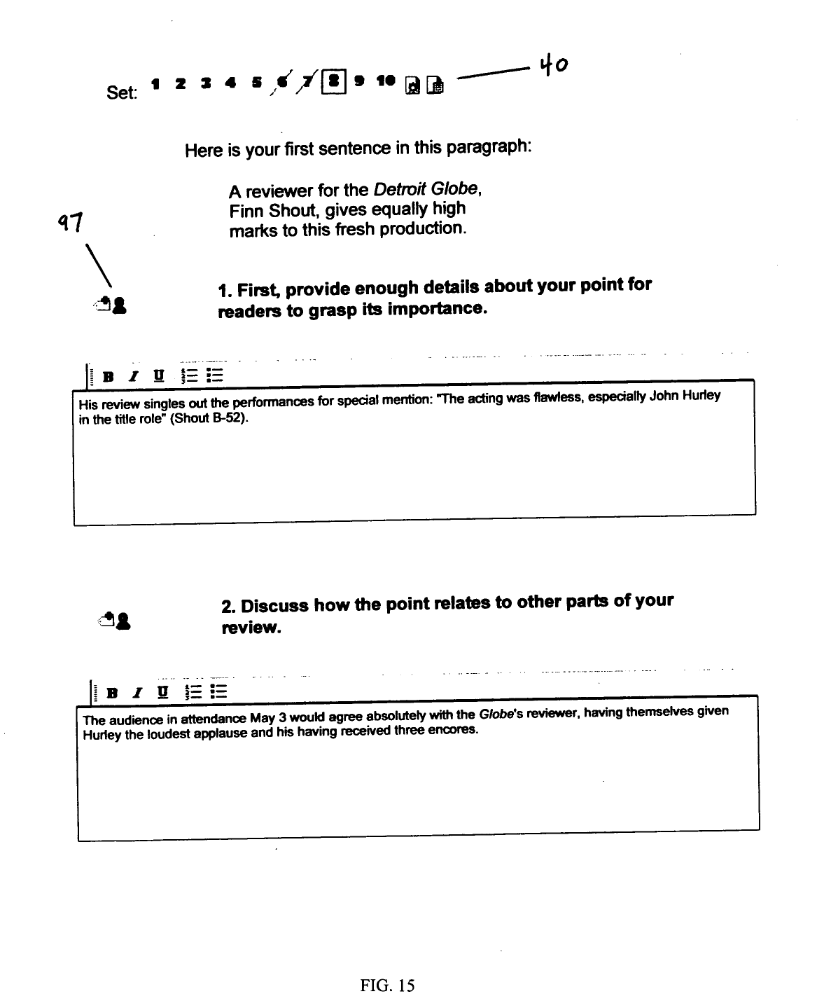

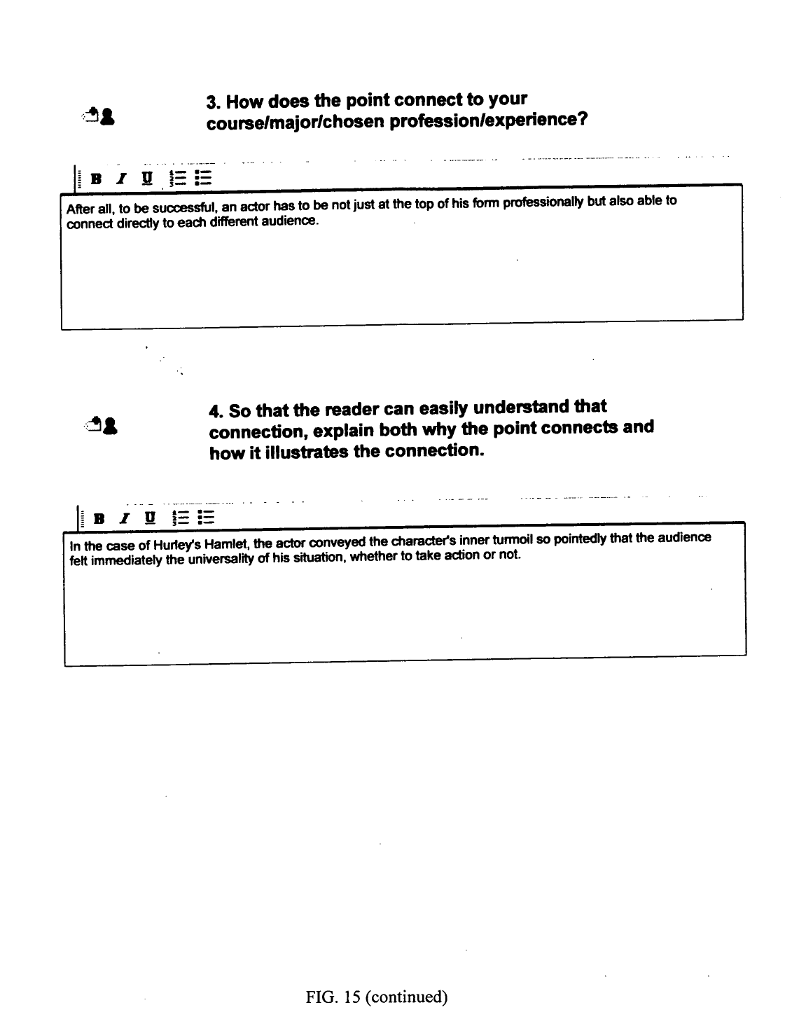

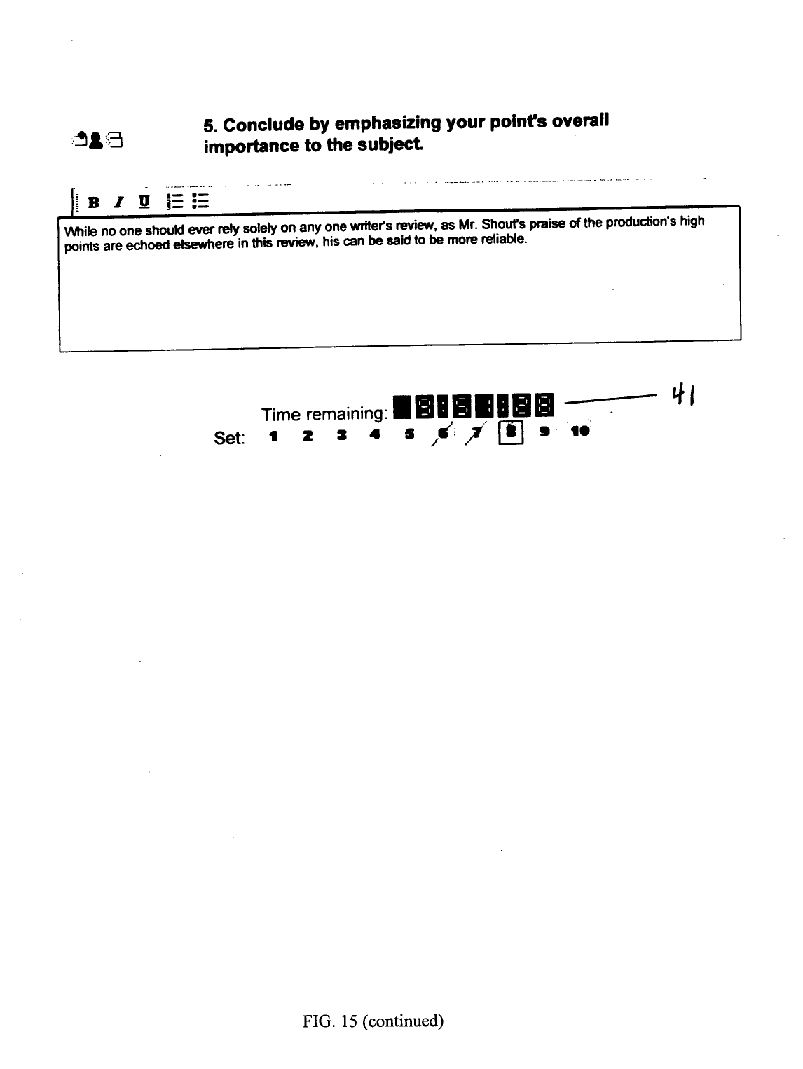

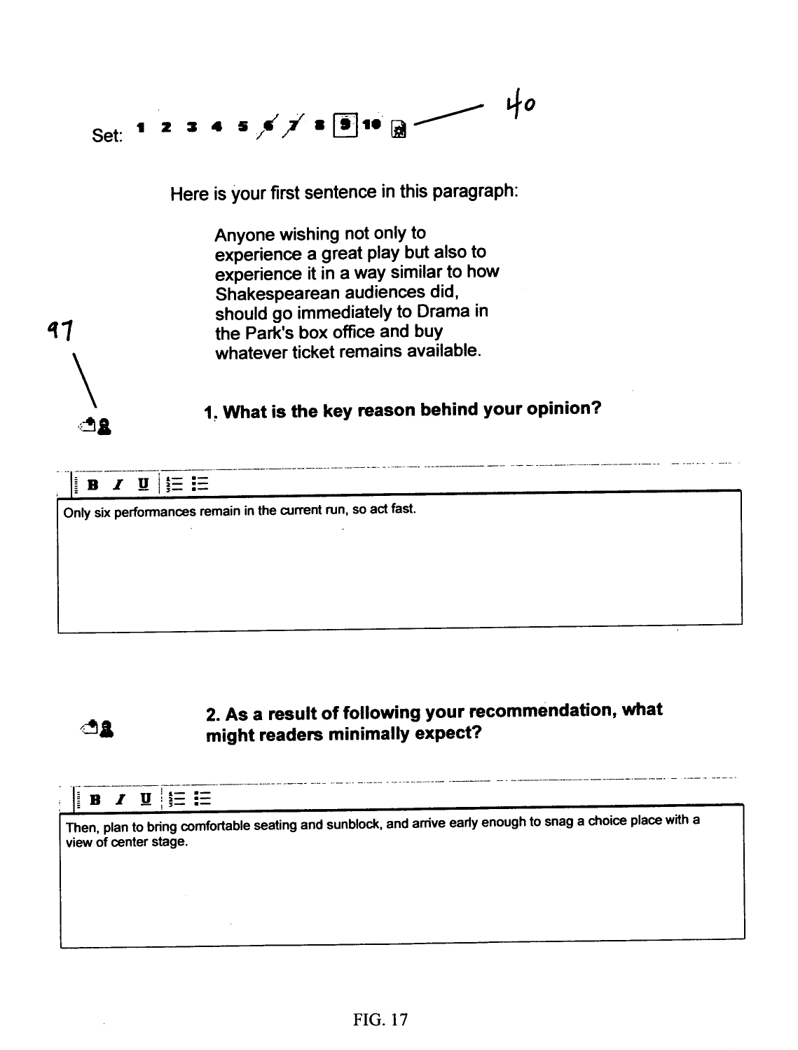

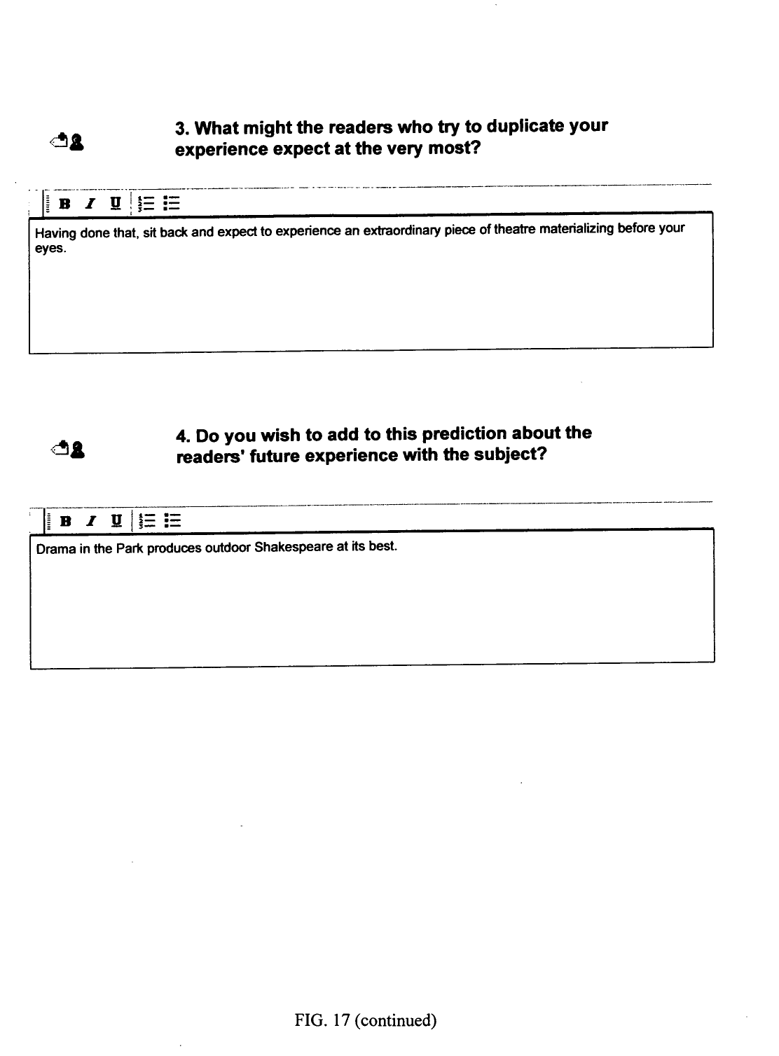

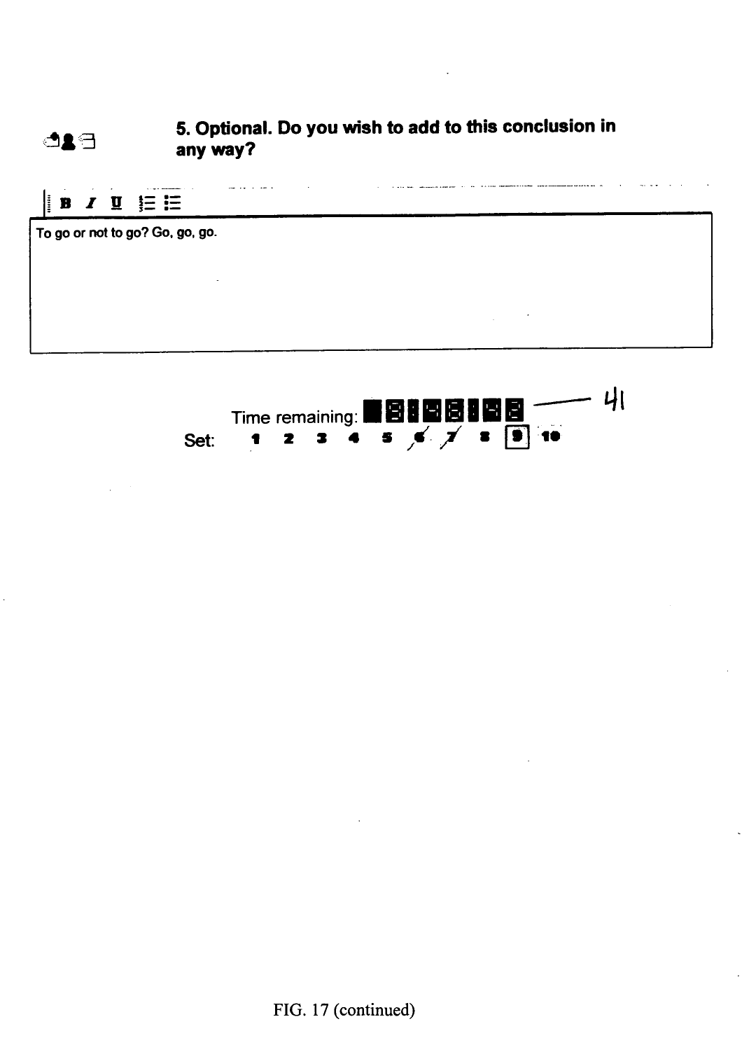

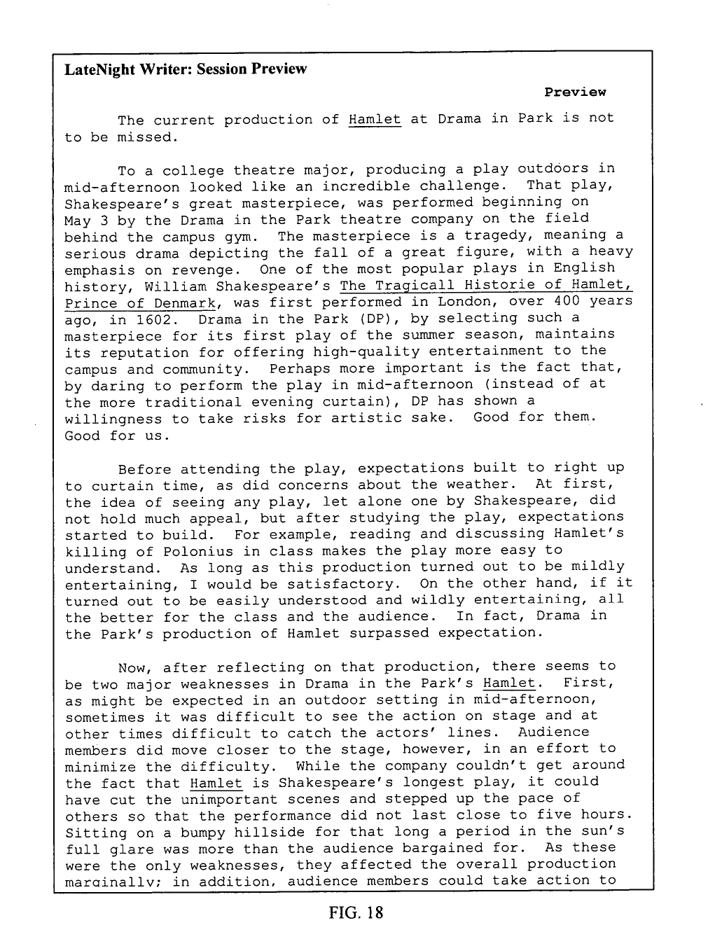

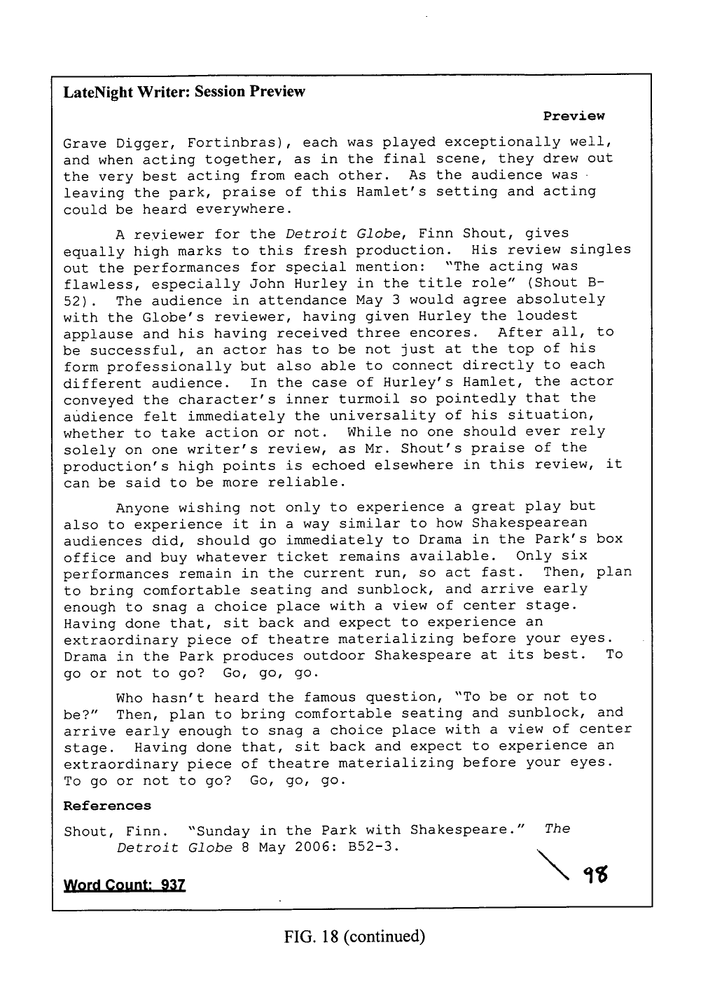

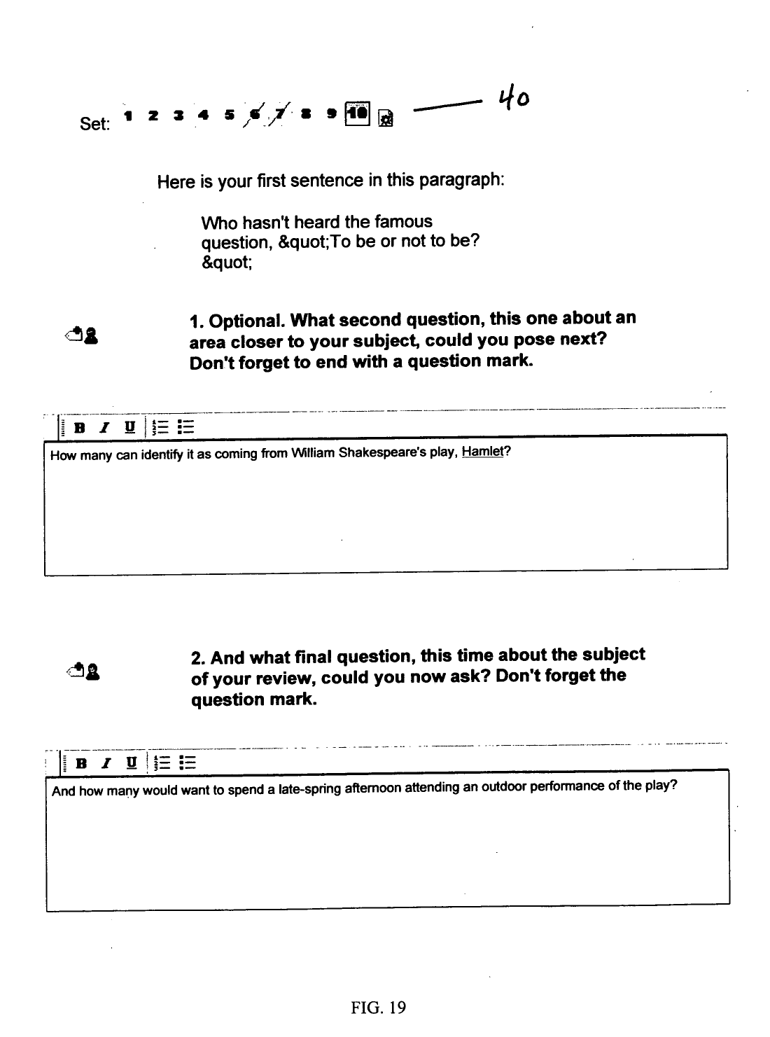

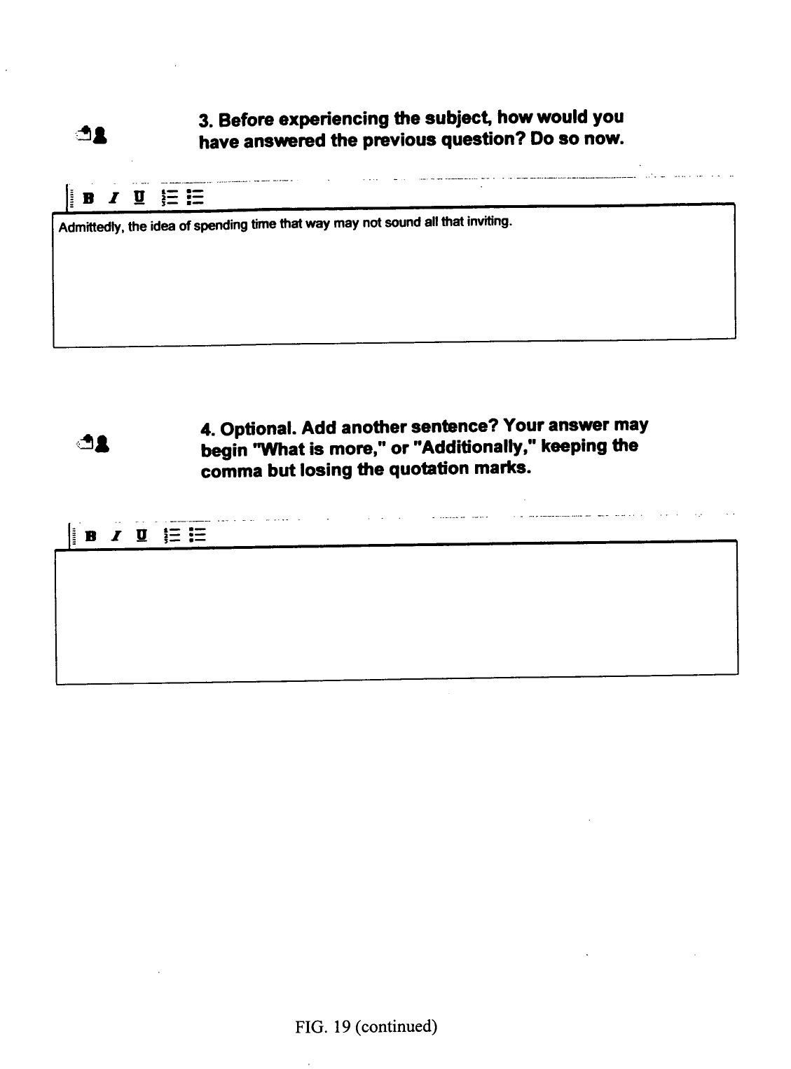

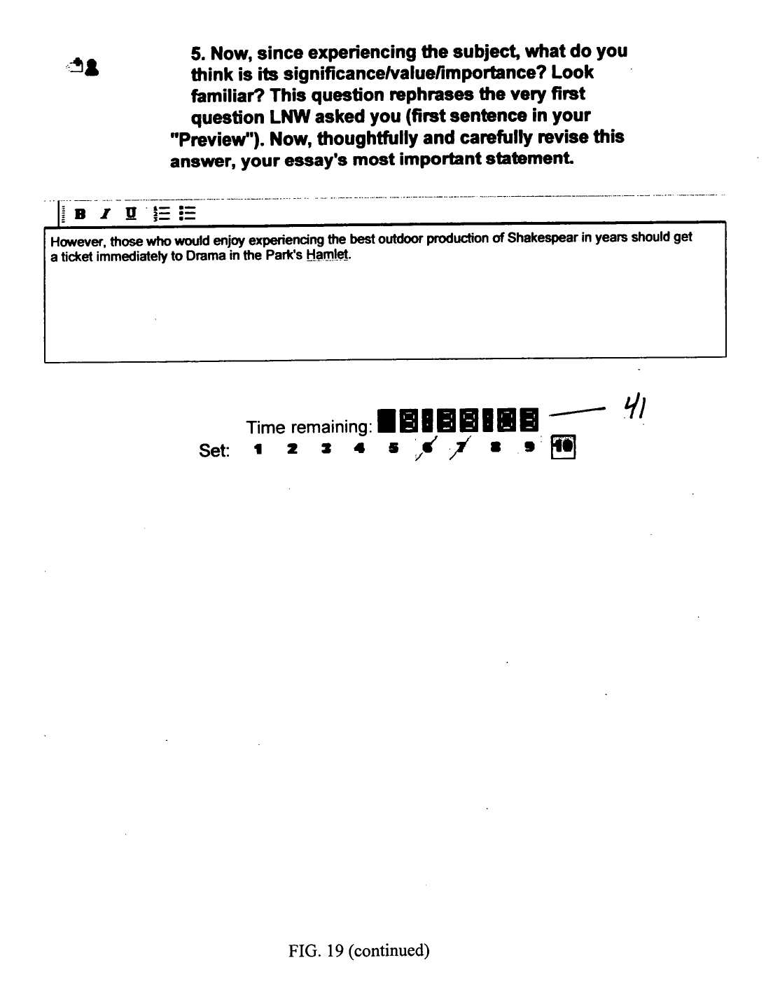

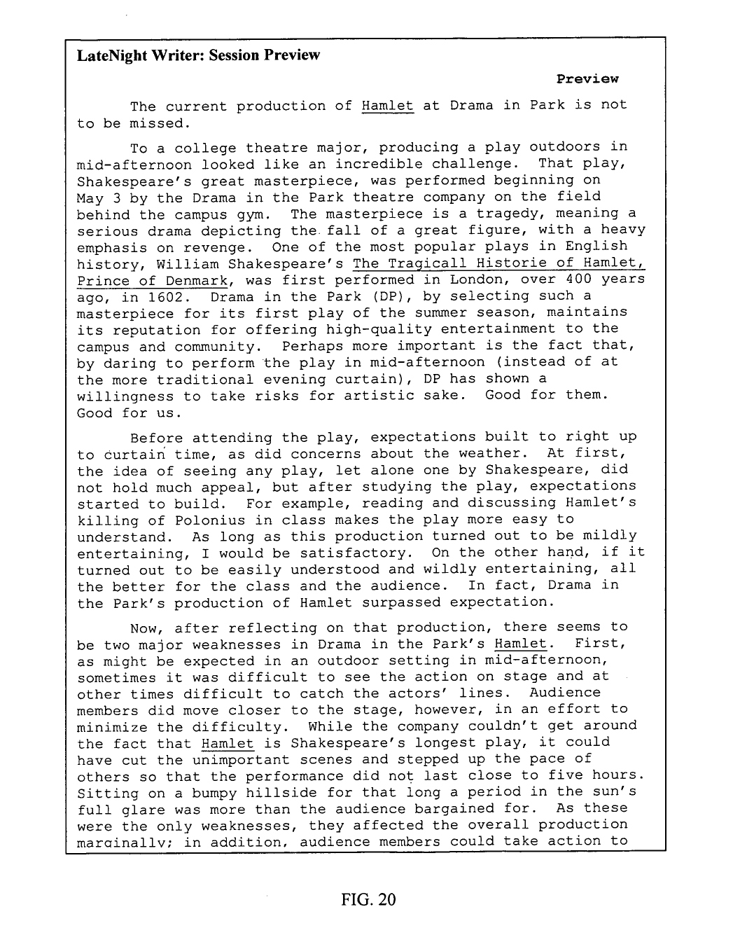

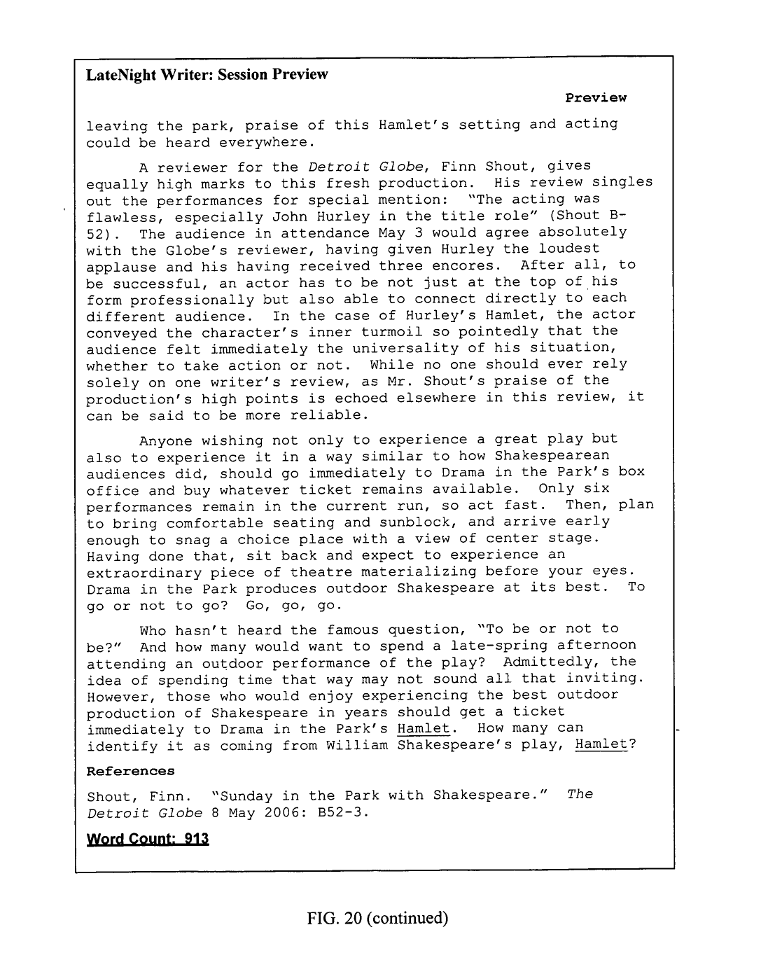

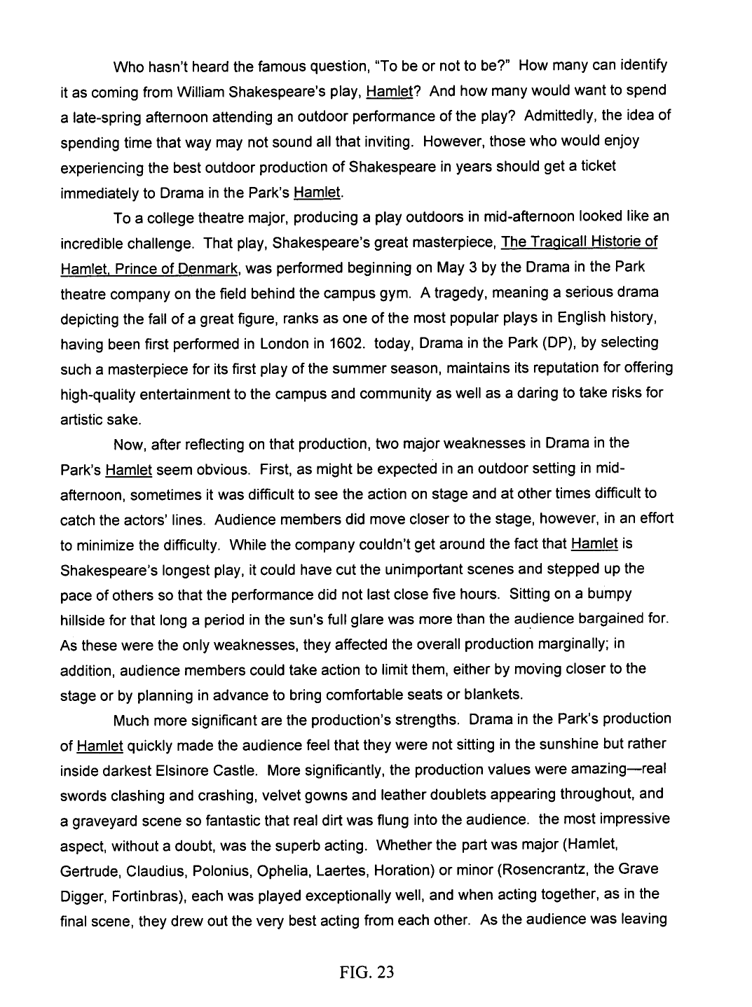

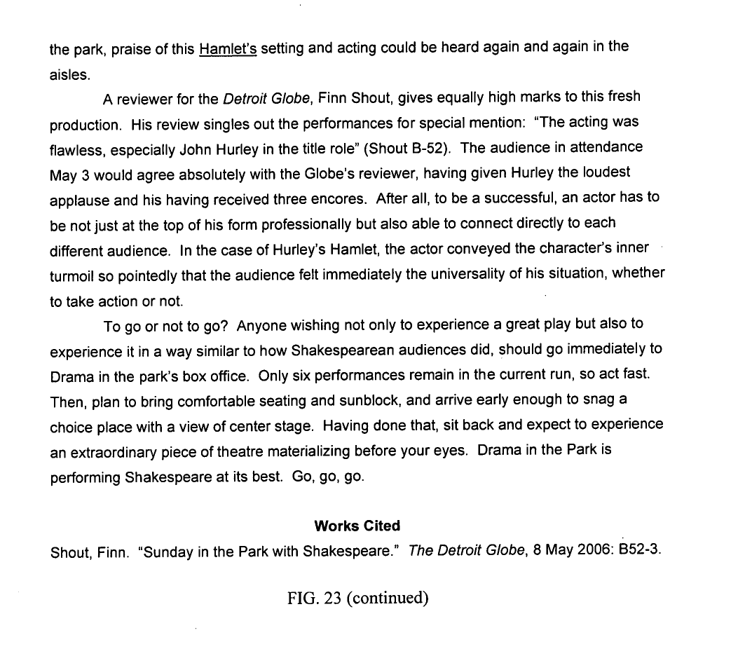

FIG. 9 shows another secondary question set, this time corresponding to primary question 52. Depending on the user's style and task at hand, these questions 82, 84, 86, 88, 90, 92, 94 may be relevant or critical. In this example, certain questions 90, 92 are optional. FIG. 10 is an updated “preview” screen which incorporates the answers to the secondary question set in FIG. 9. Similarly, FIGS. 11 and 12 show interactive screens showing additional sets of secondary questions corresponding in this case to primary question 54 and another (partial view of) an updated “preview” screen. Likewise, corresponding FIGS. 13 and 14, FIGS. 15 and 16 (showing an updated penultimate paragraph), FIGS. 17 and 18 (showing an expanded conclusion and references 98) and FIGS. 19 and 20 (showing an expanded introductory paragraph) illustrate additional secondary questions/answers and corresponding updated preview screens accessible by a user. A final preview is available, in one embodiment, after the user has answered the last question in the last secondary set, thereby generating a thesis. FIGS. 15 and 17 show example icons 97 which may be selected by a user to create a bibliography and to request advice (as in the example illustrated in FIG. 4). Such icons (or buttons, links or tabs) may be available throughout the sequence of interactive screens in this embodiment, as may be the text formatting, editing and search toolbars shown in several of the drawing figures (e.g., FIGS. 4, 5, 7, etc.). In the example illustrated in FIG. 15, question “1” at its end shows two icons—in this case a tag card with a plus sign and a human figure. Clicking the first opens the bibliography-entry form (as illustrated in FIG. 25) consisting of four fields—author, title, publication, and online info; clicking the second pops up advice. After user inputs appropriate reference data into the four fields, this embodiment rearranges the data depending on whether the Modern Language Association (MLA) or American Psychology Association (APA) system was chosen by the user, in both cases double-spacing lines, not indenting the citation's first line, but indenting all other lines. An example of the output can first be seen in FIG. 18 and also in FIG. 23. Had more than one reference been used, this embodiment would have alphabetized the collection of entries by standard bibliographic rules (by first initial of author's last name and, if no author, by title's first major word's initial character).

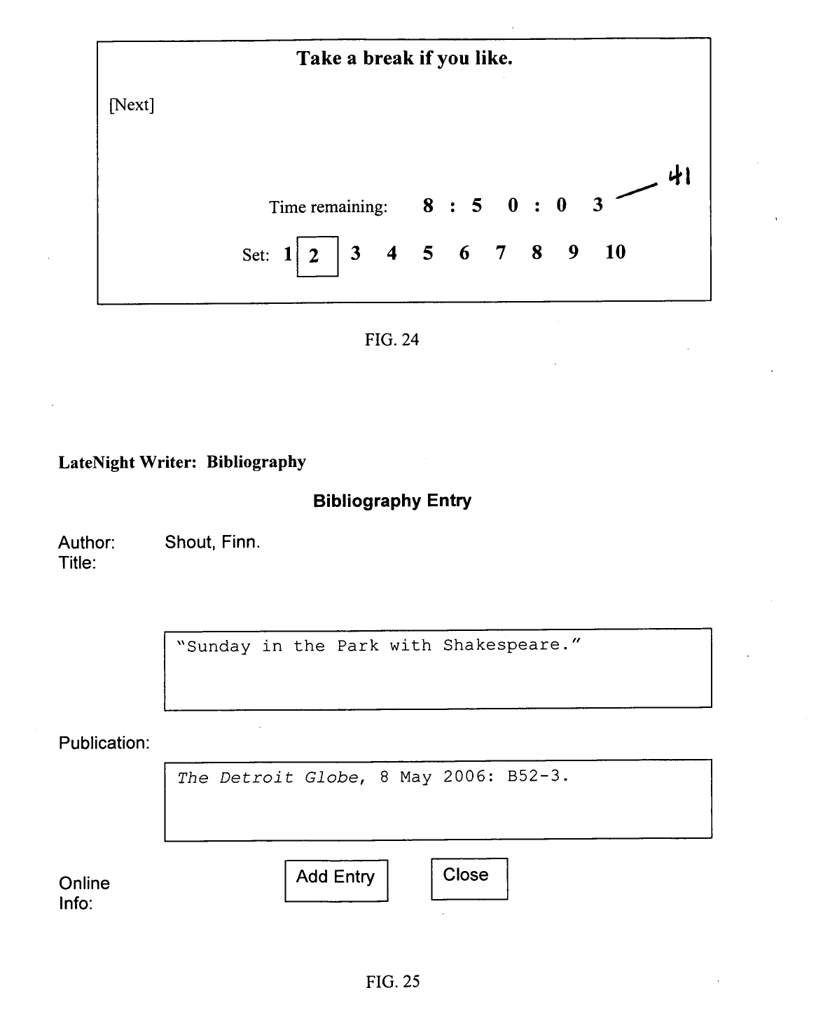

Certain screens in this embodiment allow for the likelihood that users may, after having their intellects harvested by question after question, want to create statements of their own devising (e.g., “Is any final information crucial to establish that you know the subject well? What?”). Not a question at all, nor any sort of intellectual prompt, another “question” (96 in FIG. 24) illustrates a built-in concern for the user's physical pacing of creation. Other features hold out a carrot-at-stick's end: accruing word count can be viewed in “preview” (see, FIGS. 6, 8, 10, 12, 14, 16, 18 and 20). Users of non-interactive alternative embodiments may check toolbars to access a word-count function. Users may also infer their rate of writing, thereby gauging, for example, how much longer until finished. Alternately, users may consult their own text editors for word counts or, for typewritten or handwritten writings, employ standard print calculation, based on line average of words (any combination of six characters, spaces, punctuation equals one word) multiplied by total lines.

A user of the interactive web and/or software-based system and method of the preferred embodiment continues as in FIGS. 5, 7, 9, 11, 13, 15, 17 and 19, for example, set after set, until completing a conclusion (penultimate set) and introduction (ultimate set), where the thesis is composed by answering the final question; having answered these questions, a user, whether creating a personal, professional or academic introduction, simultaneously revises the hypothesis, finished the introduction, and completed a draft in accordance with the method of the present invention. In the preferred embodiment, these revisions are made automatically upon receiving the user's answers. Afterward, the hypothesis will no longer appear in “preview” while the thesis now will appear as the introduction's finale.

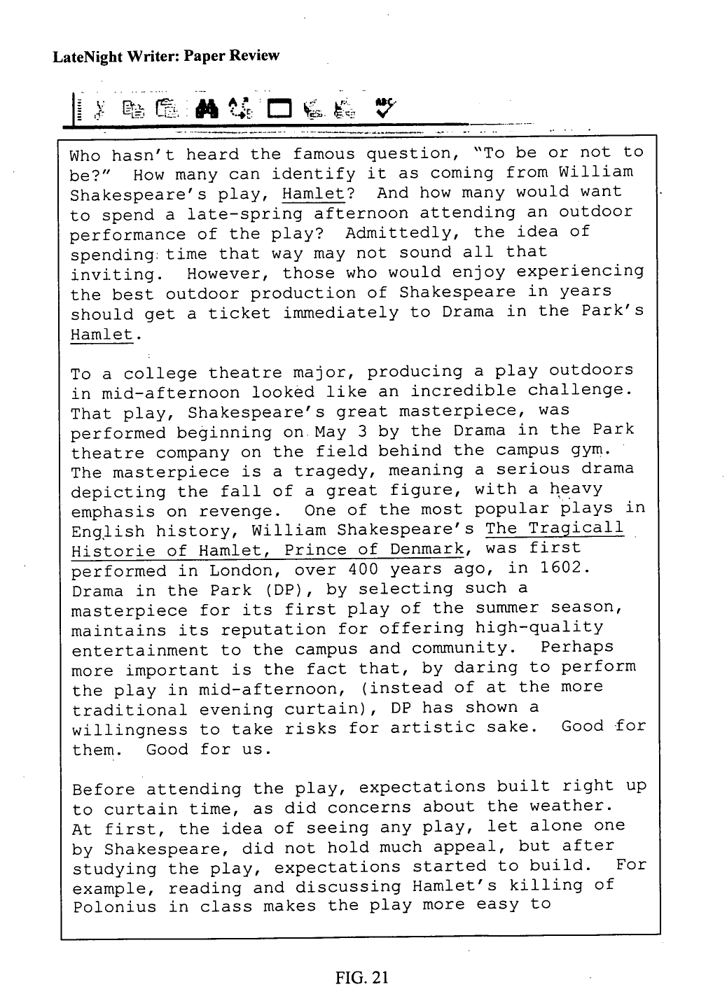

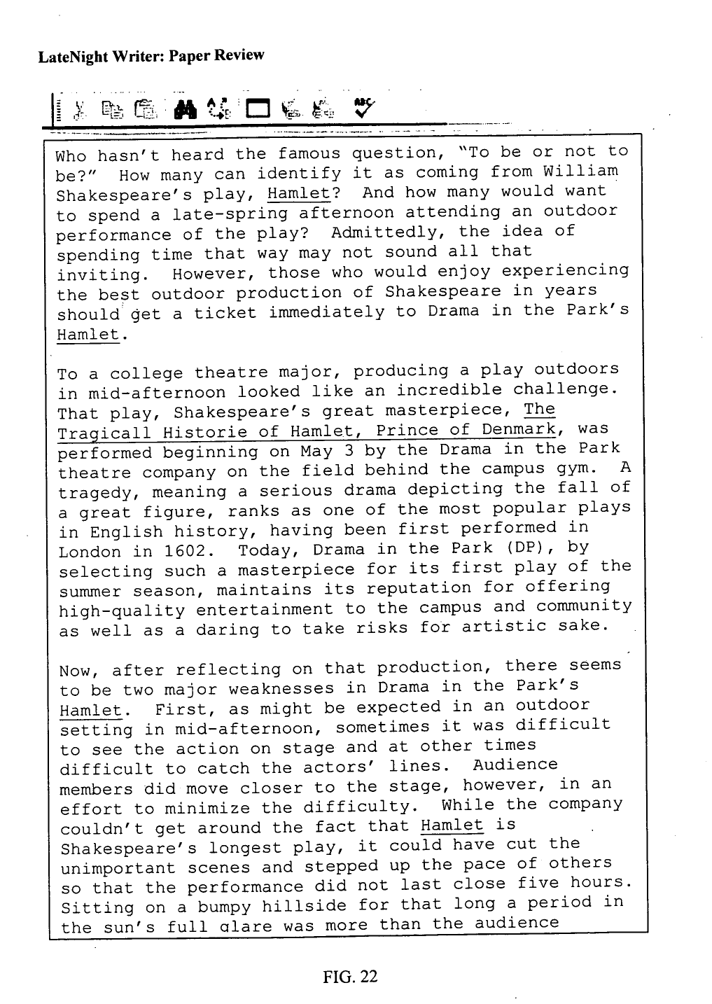

FIG. 21 illustrates an example of a screen, as would be displayed on a computer monitor, where a user may perform revisions. For example, numbered paragraphs may be reordered, as can numbered sentences; and any sentence may be revised (e.g., reworded, deleted, extended, compressed, or affected by changes in word choice, punctuation, transitional phrases, syntax, documentation, spelling, or text formatting). After revising to suit, as illustrated in FIG. 22 (which shows modifications to FIG. 21 including the deletion of the third paragraph of the writing as created by the system), the user may elect to submit by selecting an icon, button, link, tab, etc. Whereupon the system and method in this embodiment will output a writing in final form (as illustrated in FIG. 23, which shows a final copy of the writing produced in the present example, double-spaced to meet standard submission standards as well as to make the copy easier to study by speechmakers). Alternately, writers may employ cut-and-paste features on text editors or, using classic publishing practices, actually cut and paste sections, for example. The writing created in the preferred embodiment will be output in a format which may be edited by text editors and/or word processors (e.g., .doc, .txt, etc.)

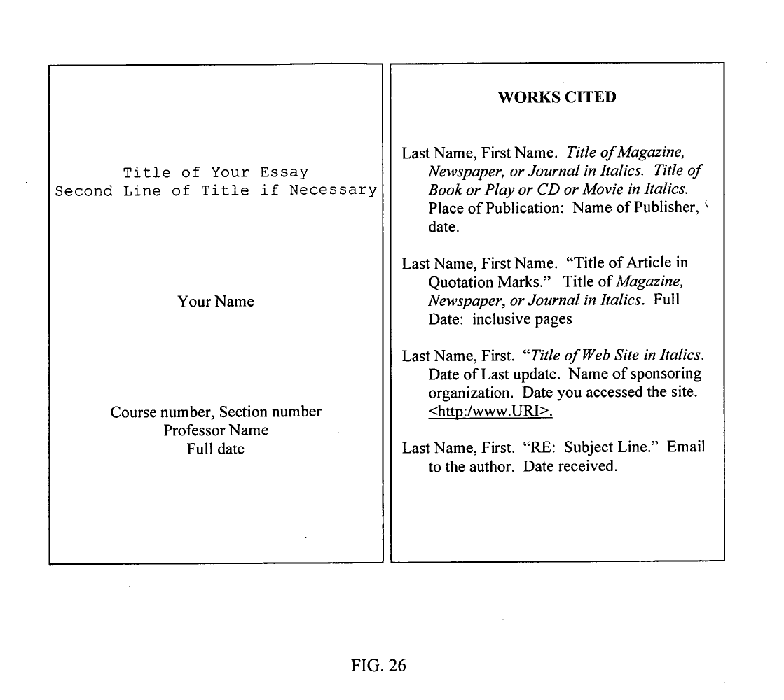

FIGS. 24 and 25 show screens suggesting that a user “take a break” 96 and assisting a user in creating a bibliography, respectively. FIG. 26 illustrates optional templates for users needing a cover sheet or, for those who included the works of others, a reference sheet, here illustrated in MLA style. Alternately, users may create references simultaneously while completing questions by following systematic prompts, depending on bibliographic styles—e.g., APA, MLA, Chicago. The system and method claimed herein may include a printer and/or means for printing.

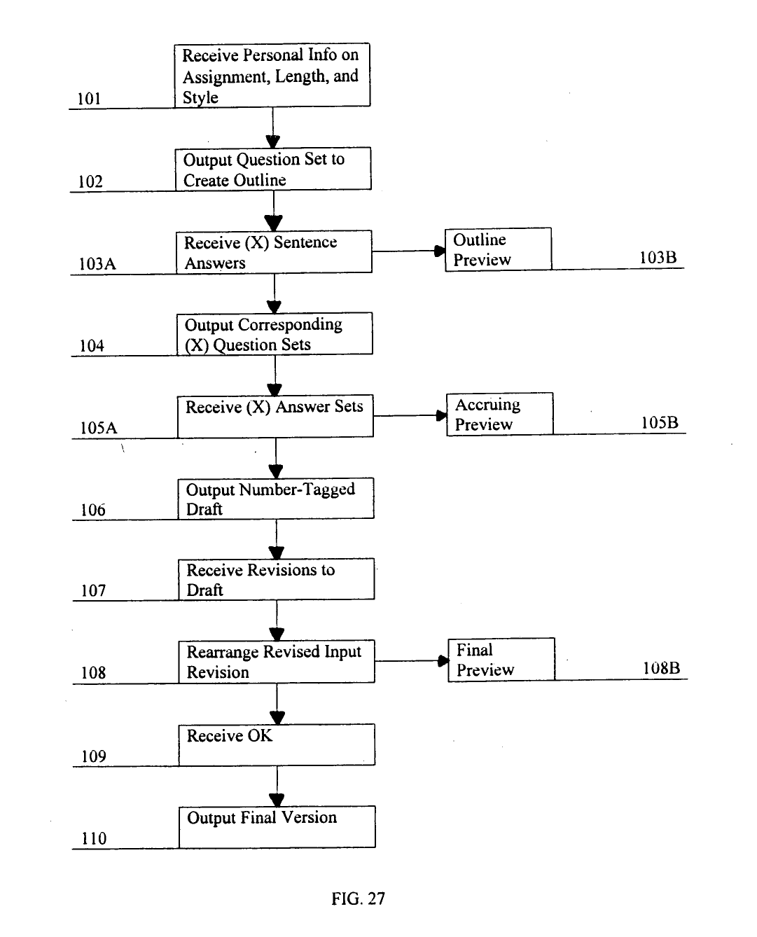

FIG. 27 is a flowchart of the method of one embodiment of the present invention. The method receives, at 101, personal information as to type, style, and length. As a result, at 102, the method outputs a number of primary questions, which the writer will answer or skip in order. The method receives the answers in step 103A, optionally may display a preview of them ordered according to type and style, step 103B. The method in step 104 outputs a series of secondary-question sets, the total number of which corresponds to the number of primary answers received. In step 105A, the method receives the answers of questions in each subsequent set that the writer deems suitable to type, style and special requirements, displaying new input and accruing word count in 105B. After completing sets, in step 106, the method outputs a number-tagged version of the sets' answers, used to reorder and revise. The method receives at 107, the revised sentence versions and reordering of paragraphs and sentences. At 108A, it executes the revisions and reordering, displaying results at 108B. A user returns to make more changes or accepts this as final, step 109, in which case, the method outputs the final copy, step 110.

The following are portions of directions/instructions for one preferred embodiment of the invention which includes “Required,” “Choice Required” and “Optional” steps:

### General Directions

Think, blink, and write a one-sentence answer

Don't worry about grammar, spelling, or using I

You'll revise later. Right now is your time to write

Required. Based on your knowledge and experience, do you recommend the subject to others—yes, no, or conditionally?

Advice

Stuck? Click Suggestion

Unsure what “subject” refers to? Check out Writing Room Help-Renaming Your Subject

Also check Writing Room Help-Titles to see if yours needs to be capitalized, italicized, or placed inside quotation marks.

Suggestion

METHOD/SYSTEM offers two suggestions, each containing choices or asking for specifics within a set of brackets. Freely adapt the wording to fit your own subject, expecting later to revise. What counts at the moment is getting an answer down.
   Two possibilities:

[Specify the subject you are reviewing] [is/is not] [absolutely/conditionally] recommended, OR

I [do/do not/partially] [recommend] [specify the subject you are reviewing].

### Set 1—Directions

Answer each question in one complete sentence

Answer all Required questions

For a Choice Required question, answer “A” or “B”—not both

Answer any or all of the Optional questions, depending on the assignment, its required length, and your strategy and mood

How many questions you answer here determines how many more sets you must complete afterward. Answering six of the questions below, for example, will result in your being given six more sets to answer later

Each of those later sets will develop into a paragraph, which will fill a third to a half of a page

Between the minimum of six and the maximum of nine paragraphs, your review could reach two to six double-spaced pages

Accordingly, plan a smart strategy: answer every question below and decide after completing all sets which to keep and delete, or answer six questions here and finish the minimum six sets as quickly as possible

Choice Required. Readers want first to be told important facts about the subject's beginnings. Answer “A,” and not “B,” if you had to be present in person to experience the subject (for example, a concert, a performance, a play, an exhibition, a program, and so on).

A. When and where did the subject take place?

Advice

Use the past tense to express your answer. Check Suggestion

“When” could be a year, week, day, or time of day (Thursday evening); a date (Oct. 16, 2005); or another indicator of time (during semester break).

“Where” could be a building (Eiffel Tower), a city (Bombay), or another place indicator (the Middle East).

Because even a small factual mistake may reduce your grade, METHOD/SYSTEM urges you to double check dates and spellings in your subject's program, brochure, or similar reference material.

Do not quote from such material. Check Writing Room Help-Documentation

Suggestion

METHOD/SYSTEM realizes that getting started can be a slow process. If that's true for you, here is a startup suggestion, which contains pairs of brackets, each pair either offering multiple-choices or asking you to supply specific information. Freely adapt the wording to fit your own subject, expecting later to revise. What counts at the moment is getting an answer down.

[Specify not the subject but a larger grouping to which it belongs] [was held/took place/was performed/opened/began/started] [at/on/in] [indicate place] [at/on/during/in] [indicate time].

Choice Required. Answer “B,” and not “A,” if the subject was recorded, printed, digitized, filmed, or taped—for example, a book, a movie, a DVD, a television series, a video game.

B. Who created the subject? When? Where?

Advice

Create one sentence to answer all three questions:
1. Include first and last names of the creator (author/director/composer).
2. Give a geographical indicator, such as country or city.
3. Use a time indicator, such as date (19 Jul. 1997 or Jul. 19, 1997) or year (1998) of creation, birth, death, or a major achievement.

You may add any fact you believe is also significant or relevant.

Check Suggestion

Because a single factual mistake may reduce a grade on a paper, METHOD/SYSTEM urges you to double check your subject's cover, brochure, or similar material for correct dates and spellings of proper names.

Do not quote from such material. Check Writing Room Help-Documentation

Suggestion

METHOD/SYSTEM realizes that getting started can be a slow process. If that's true for you, here is a startup suggestion, which contains pairs of brackets, each pair either offering multiple-choices or asking you to supply specific information. Freely adapt the wording to fit your own subject, expecting later to revise. What counts at the moment is getting an answer down.
   Your answer could adapt any one of these combinations:

[Specify when], [specify first and last name] [created/recorded/published/produced/emceed] [rename subject by pronoun or generic group] [specify where].

[Born in/From/A native of] [specify where], [specify first and last name] [created/recorded/published/produced/emceed] [rename subject by pronoun or generic group] [in/around/on/during] [specify when].

[In/Around/On/During] [specify when], [specify first and last names], who [specify an additional relevant or significant fact], [created/recorded/published/produced/emceed] [rename subject by pronoun or generic group], while [living/studying/visiting/] in [specify where].

Required. Identifying imperfection is a reviewer's responsibility. Before answering, eliminate from consideration any negatives that might be petty, unrelated, or offensive.

How many negatives should you point out to your readers—two, three, four, or more?

Advice

Answer with either a number or a descriptive term, like several or countless.

Zero or one is not an option. You'll have to find at least two negatives—perhaps a major and a minor flaw.

Do not specify any of the imperfections in this answer; that will come later.

Spell out the number (one, two, three, four); don't use numerals.

See Suggestion

Suggestion

If stuck, consider creating an answer now from these suggested parts and revising later.

[Specify either a number from two to four or a descriptive term] [weaknesses/flaws/shortcomings/drawbacks] [exist/occur/can be found/can be located/can be identified/can be observed].

Required. Now, readers are ever more eager to learn what you like most about the subject.

Above all others, what single quality or feature deserves highest praise?

Advice

Name just one—the one that comes to mind now as being the most impressive. (A later question will ask for other positives.)

Check Suggestion

Suggestion

If stuck, consider creating an answer now from these suggested parts and revising later.

[In contrast/However/On the other hand], the [greatest/most impressive/most significant] [highlight/strength/feature/quality] in [specify the subject's full name or title] is [simple/easy/easier/obvious/less obvious/hard/harder/difficult/less difficult/more difficult] to [observe/identify/enumerate/locate/pinpoint/find].

Optional. Often readers value a reviewer who, having identified the positives and negatives, can also uncover a subject's exceptional quality—one that other reviewers may have missed.

What truly surprising, unique, unusual, or otherwise unexpected feature deserves special mention in your review of the subject?

Advice

For this question, think outside the box to uncover a subject's unusual feature (or perhaps an unusual but related event that happened while you were experiencing the subject).

Such a mention would not be made in all reviews. In fact, its mention here can make your review stand out.

See Suggestion Also see Writing-Room-Renaming the Subject

Suggestion

If stuck, consider creating an answer now from these suggested parts and revising later.

[Rename the subject of your review in a few words or use a pronoun], [in addition/moreover/interestingly enough], also [contains/possesses/exhibits/has] an [unexpected/unique/unusual] [feature/component/aspect/quality].

Optional. Often, readers appreciate when a reviewer judges the subject against others like it.

In your estimation, when compared with similar subjects, where does this subject rank—at the top, far below, or somewhere in between?

Advice

Let your intellectual instincts guide you. For example, you may state a simple ranking against the best and the worst of similar subjects.

And remember this: because your instructor wants a candid opinion, your answer can't be incorrect.

Suggestion

If stuck, consider creating an answer now from these suggested parts and revising later.

[If/When/After being] [weighed against/put side by side with/lined up with] the other [specify the larger group to which the subject and those like it belong—for example, books/movies/plays/lecturers/experiences], [specify the subject by renaming or shortening its full name or title] [ranks/rates/deserves a place] [below/above/as an equal/in the middle/at the top/at the bottom].

Optional. Create your own METHOD/SYSTEM paragraph. Given your assignment's requirements, what critical question has METHOD/SYSTEM not asked? Or aside from those requirements, would you like to explore an additional point about the subject? In either case, mentally ask yourself the question and then answer it here.

Advice

Double check your assignment sheet or notes to see if discussion of a special point is required. No sheet or notes? Check your textbook's table of contents and your instructor's website for a possible special point to include.

If your assignment requires more than three pages, you could raise a relevant point not previously mentioned, or you could expand on a previous point; for example, you might compare this subject with one already studied in your course or major.

Click Suggestion

Suggestion

If stuck, consider creating an answer now from these suggested parts and revising later.

Consider this/One final/One last/Another] point: [specify it].

Required. Readers want your final opinion of the subject in one short sentence. What's the primary reason others should experience (or not experience) the subject?

Advice

Your readers expect a realistic opinion. Because you, the reviewer, represent the public when determining if time, energy, and other resources (such as money) should be expended to experience the subject, you should aim to be as objective as possible.

Suggestion

METHOD/SYSTEM realizes that getting started can be a slow process. If it's true for you, here are some startup possibilities. Adapt them freely; revise later.
   Two possibilities:

[Absolutely/By all means/With lowered expectations/Having been alerted in advance], [do/do not] [specify an action—read/attend/enroll in/buy a ticket for/eat at] [specify the full name or title of the subject] because it is [give one or two descriptive words—incredible/predictable/so enjoyable].

[Attend/Read/See/Don't miss/Go to/Skip/Avoid] [specify the full name or title of the subject].

Choice Required. Answer either “A” or “B”—not both. Your answer here will become the introduction's opening sentence. Which to choose? Either works, so think, blink, and write—don't stress.

A. Revealing a change in yourself can hook readers' attention as effectively as any before-and-after advertisement. In this case, readers are keen to learn what your attitude was before experiencing the subject—for instance, before attending the concert, hearing the guest speaker, or reading the book.

When first given the assignment, what were you expecting?

Advice

Be honest, but not insulting. After all, your professor will be reading the review, and professors are human beings, too.

Click on Example

Example

At first, attending a workshop outside of class during free time was not very appealing.

B. High-school papers notoriously begin with a general statement. Don't start that way. Instead, start the METHOD/SYSTEM way, by turning a general statement into a question. What statement broadly connected to the subject can you reword as a question?

Advice

Almost any short statement related generally to the subject will do the trick. Don't forget to end your answer with a question mark.

Example

Given the various forms of entertainment saturating our culture, why waste time reading classical literature?

### Set 2A—Directions

Look below for your previous answer from Set 1: it has become the opening sentence in your review's second paragraph
Now to complete that paragraph, answer these questions
Unlike the last set, you may now write answers of more than one sentence; in fact, sometimes you'll be asked or advised to do just that
Also unlike the last set, skip any question—even a Required one—that doesn't relate to your subject
Aim to include factual details in your answers

Required. How did the subject begin? What followed?

Advice

Answer each question in a separate sentence. If you'd like to combine the sentences using a semicolon, consult Example Suggestion

By the way, do not mention how the subject ended—that comes later.

To include facts, check Documentation

Suggestion

Write the answer to your first question and end with a semicolon; then continue the sentence (starting with a lowercase letter) with your answer to the second question.

Sentence 1; sentence 2.

Example

Mozart's Piano Sonata in D [opened/began/started/headed] the concert; [next/after that/then], the orchestra [played/continued with/presented] two shorter pieces—a Tchaikovsky march and a Bach fugue.

Documentation

Include facts—the time, for example—which do not need to be documented.

METHOD/SYSTEM cautions against quoting sources in this answer. Instead, use your own words to express any fact.

Required. Who were the major participants?

Advice

In your own words, identify participants by their full name, adding relevant facts such as titles or positions, if you like.

Again, check the web or printed material to be sure of facts and spellings—but don't quote.

Example

Dana Obbo, who has taught in the Middle East for a decade, headed the university's program while the local tours were led by Adrian Alan, an archeologist who has written extensively about the pyramids.

Optional. Who sponsored, arranged, or produced the subject? If the subject was intended to serve a purpose, what was that purpose?

Advice

Identify the sponsor—the college, company, nonprofit association, government agency, or the like—by full name. Again, spelling and capitalization count.

If the sponsor has expressed an intended purpose, you may quote it, either from memory or from an online or printed source. See Example Follow instructions at Documentation

If the sponsor hasn't expressed an intended purpose, you may express in your own words what you believe that purpose to be; in this case, there is no need to document. See Example

Optional. Do you have important additional information about when, where, how, what, or who? Add it here.

Advice

Answer if you need to include information about the subject required by your assignment.

Or answer if you'd like to expand the discussion to include other details—for instance, details about the audience.

Required. When and how did the subject come to an end?

Advice

For “when,” indicate either a measurement of time that has elapsed since the subject's start (hours, acts, scenes, movements, etc.) or describe a realization of the passing of time—for example, “all too soon” or “before I realized” or “too many hours later.”

For “how,” give a simple factual description—that is, one without criticism.

Check Suggestion if you're wondering where to put the commas in your answer.

Suggestion

Your answer could use one of these combinations.

After [when], [specify the action] came to an end [how].

[Specify the action] ended [how] after [when].

[Specify the action], [when], ended [how].

### Set 2B—Directions

Look below for your previous answer from Set 1: it has become the opening sentence in your review's second paragraph
Now to complete that paragraph, answer these questions.
Unlike the last set, you may now write answers of more than one sentence; in fact, sometimes you'll be asked or advised to do just that
Also unlike the last set, skip any question—even a Required one—that doesn't relate to your subject
Include factual detail in each of your answers
   Required. In what locale and during what time period does the action take place?
   Advice

Use the present—not the past tense—to express your answer. Check Example

The time may be exact (Jun. 6, 1944), generalized (World War II), or inexact (in the first half of the twentieth century).

If you are unsure of facts or spelling, consult the subject's accompanying printed or online material. Do not rely on memory or other reviewers, who may not have consulted the necessary material. A mistake can reduce your grade.

As above, do not quote from such material. Check Writing Room Help-Documentation

Example

Shrek takes place in a faraway but entirely familiar fairy-tale kingdom in what looks like a cartoon version of today. (Notice that the sentence uses the present tense: it says “takes place,” and not “took place.”)

Documentation

Include facts—the locale, for example—which do not need to be documented.

METHOD/SYSTEM cautions against quoting sources in this answer. Instead, use your own words to express that fact.

Required. Among the subject's major characters/players/participants, who should be identified for the readers of your review?

Advice

“Who” could an individual or a group.

Include two to four characters in your answer by name and identifying features. Check

Example

Spelling counts here. Trust METHOD/SYSTEM to know this.

Example

The ogre with attitude named Shrek is joined by five others—the feisty donkey sidekick, the delightfully human Princess Fiona, her royal parents, and the evil Lord Farquaar. (Notice the continued use of the present tense: Shrek “is,” not “was.”)

Required. What are the characters/players/participants you just identified doing at the beginning (when you first experience them)? What happens to them by the midpoint?

Advice

Answer each question in a separate sentence.

If you'd like afterward to combine them in a more sophisticated way—for instance, using a semicolon—click on Suggestion Example

Do not mention what happens after the midpoint.

Suggestion

Write the answer to your first question and end with a semicolon; then continue the sentence (starting with a lowercase letter) with your answer to the second question.

Sentence 1; sentence 2.

Example

The novel opens with these characters alone and vaguely depressed; halfway through, they have become good friends but are just as depressed.

Optional. If significant, who produced, published, or distributed the subject? Also if significant, was a cause involved?

Advice

Answer only if relevant to your subject.

Identify the producer/publisher/distributor—the person, company, nonprofit association, government agency, or the like—by full name. Again, spelling and capitalization count.

If the producer/publisher/distributor has expressed that a cause is being served, you may quote that from a source. If you do, check Documentation.

If no specific cause is stated, you may express in your own words what you believe that cause may be; in this case, there is no need to document. See Example

Example

No documentation needed:

Hyannis Audio Studios will donate a portion of its profits from the recording to benefit disabled children in the community.
   Documented using MLA style:
According to the studio's site, “25% of its profits will be pooled for disabled children under 18 living in Barnstable County” (“Music Always Helps”).
   Optional. Do you have important additional information about when, where, how, what, or who? Add it here.
   Advice

Answer if you need to include information about the subject required by your assignment.

Or answer if you would like to mention the subject's central theme or its appeal to general audiences.

Required. When and how does the action come to an end?

Advice

For “when,” indicate either a measurement of time that has elapsed since the subject's beginning (hours, acts, scenes, movements, etc.) or describe a realization of the passing of time—for example, “all too soon” or “before I realized” or “too many hours later.”

For “how,” give a simple factual description—that is, one without criticism.

Wondering where to put the commas in your answer? Check Suggestion

Suggestion

Your answer could use one of these combinations.

After [when], [specify the action] came to an end [how].

[Specify the action] ended [how] after [when].

[Specify the action], [when], ended [how].

### Set 3—Directions

Focus solely on the negatives you should bring to the attention of your readers:

Use the synonym for negative that best suits your subject and assignment—flaw, shortcoming, inadequacy, failure, fault, weakness, limitation, drawback, problem, disappointment

As before, while only one sentence is required, writing longer answers is ok, too

Similarly, skip unrelated questions

Required. Among these negatives, which minor one(s) should be mentioned first?

Advice

Here you should identify the one you consider the slightest or most trivial.

If the subject has four or more negatives, in this answer identify the two you consider to be the slightest or most trivial.

In either case, save the major negative(s) for identification in the next questions.

Optional. Which fault is more significantly negative—and why?

Advice

If you are identifying a total of two negatives in this set of questions, do not answer this one. Skip and continue to the next question.

If you are identifying more than two negatives, you must answer this one.

See Suggestion Writing Room Help

Suggestion

To help readers understand that this fault is more significant than the minor one(s),

METHOD/SYSTEM recommends including a term of comparison—

more, worse, lesser, better

Required. What is the most negative feature about the subject?

Advice

Answer confidently.

Don't exaggerate.

See Suggestion Writing Room Help

Suggestion

As before, METHOD/SYSTEM recommends including a word indicating comparison—in this case, a superlative

most, least, worst, or weakest

Required. In your opinion, why is this feature the most negative?

Advice

Take care explaining the basis for your opinion. Why? So that readers, who have not had your experience, can appreciate the degree to which the subject is imperfect.

Don't fret or worry that there can be only one right answer here. There can be many.

Trust your intellectual instincts. Writing Room Help.

Optional. Do you have information about the subject's weaknesses? If so, add it here.

Advice

For instance, you may add other important information to this discussion of the subject's imperfections, or perhaps you need to include something required by your assignment.

If you don't, that's okay, too.

Required. Taken together as a group, how did these negative qualities affect your overall appreciation/estimation/evaluation of the subject?

Advice

Pause a nanosecond to consider how to answer effectively.

Check Suggestion for possibilities to include in your answer.

Suggestion

Consider inserting a transitional expression, such as one of these, into your answer:

minimally/marginally/partly/greatly/wholly/somewhere in between/twenty percent/fifty-fifty/absolutely/momentarily/not in the least

### Set 4—Directions

Switch to positives here:

Use the synonym for positive that best suits your subject and assignment—a valued, respected, appreciated, worthy, impressive, notable, remarkable, quality, feature, characteristic, aspect, trait, part

Detailing what's most outstanding about your subject will convince readers of the depth of your knowledge—and raise your grade

Again, it's ok to think quickly, write multiple-sentence answers, and skip irrelevant questions

Required. Which in-depth detail about this superior quality or feature should you provide for the readers—who or what is involved, doing what, where, and for what purpose?

Advice

You may need two sentences, perhaps three.

If so, see Suggestion for effective ways of combining sentences.

See Writing Room

Suggestion

Your answer could use one of these combinations. Do pay attention to punctuation and capitalization.

Sentence 1, [yet/but/or/so/for/and] sentence 2.

Sentence 1; sentence 2.

Sentence 1; [in addition/also/additionally/in contrast/however/meanwhile], sentence 2.

Sentence 1, [yet/but/or/so/for/and] sentence 2. Sentence 3.

Sentence 1; sentence 2; [in addition/moreover/also/in contrast/however/meanwhile], sentence 3.

Required. Are there other positive qualities and features that deserve honorable mention? If so, what are they? If not, why not?

Advice

Answer the first in a simple statement, ending not with a period but with a colon.

Continue by answering the second question after the colon.

Suggestion

There are two forms here, so you'll want to pay close attention.

If there are other positives:

[Countless/Abundant/An equal number of/A handful of/A few] [features/qualities/aspects/components/parts] [are/seem/should be/must be/ought to be] [noticed/mentioned/pointed out/identified]: [briefly identify each, separated by commas.] OR

If no other positives:

[Amazingly/As might be expected/Surprisingly/Not surprisingly/Predictably], [no other/not another] [feature/quality/aspect/component/part] [deserves/merits/has earned] [mention/notice]: [specify the reason why not].

Optional. What important information might be added to this discussion of the subject's excellence? Add it here.

Advice

Answer only if relevant.

Required. Is your choice of positive features likely to be echoed by other reviewers—a majority, a minority, or none?

Advice

Likely is key to answering. Because you are making an educated guess, you can't go wrong.

Do not quote: you are either guessing, which doesn't need to be documented, or relying on memory, which doesn't either. Check Writing Room-Documentation

### Set 8—Directions

To bring your additional point into focus, imagine yourself as the reader of this review:

Point may be a synonym for idea, suggestion, thought, proposal, consideration

Taking a minute to recheck your assignment for specific or suggested needs would be smart

Required. To grasp your point easily, what minimum facts do readers need right here?

Advice

Include any or all of the following:

who or what is involved

doing what

where

for what purpose

Required. Does your point relate to other parts of your review (negatives, positives, unexpected feature, ranking)? If so, how does it—or if not, why doesn't it?

Advice

Readers like either seeing parts of an essay connected or learning why they can't be.

Answer both questions in complete sentences.

However, begin your second answer with Because/Since/Although/While

Then switch your sentences, following Suggestion Example

Suggestion

Don't forget the comma. Don't begin sentence 1 with a capital letter.

Because/Since/Although/Even though/While sentence 2, sentence 1.

Example

1. Because this point is connected to the previous discussion of ranking, it deserves a closer look.
2. Although it might not appear to be directly related to the discussion at hand, this point should be looked at more closely.

Required. Why does this point deserve discussion in the review? Can you add an example?

Advice

Readers like when a point is proven by an example, especially by one they can quickly grasp.

Optional. How does the point connect to your course, major, chosen profession, or experience?

Advice

This could be a bonus, especially if your instructor likes students to refer to any of these matters

Required. In what way does this point contribute to your review of the subject?

Advice

You may wish to include a word or phrase indicating that this is the paragraph's final sentence.

Possibilities? Click on Suggestion

Suggestion

Consider including a transitional expression, such as one of these, to start your answer:

Finally,/Overall,/Interestingly enough,

### Set 9—Directions

This short set effectively creates your conclusion:

Readers, noticing that it's the last paragraph, won't appreciate any words to that fact: avoid mention of conclusion or concluding or final or finally

They would instead appreciate reading a mixture of short and long sentences among your answers

Required. Are there other important reasons behind your opinion/recommendation? If so, what are they, or if not, why not?

Suggestion

Answer the first question in a short statement of fact. End with a colon, not a period. Answer the second question after the colon without capitalizing its first letter.

Example

A. If so:

Other considerations prompt [this/my] recommendation: the dazzling performances by the lead actors and the unconventional set design.

B. If not:

No other reason is necessary for downloading the CD: music doesn't get any classier than this.

Optional. What are the conditions, if any, under which readers should experience the subject?

Advice

Even if you don't have any, you could also answer this question by describing the most ideal conditions under which the subject should be experienced.

Optional. Minimally, what should anyone who follows your recommendation expect?

Advice

The stress here is on minimum expectations, so describe the lowest expectations anyone should have.

By the way, because you're guessing intellectually, don't worry about being right. You can't be wrong.

Suggestion

Consider using a variation of one of these words, or something similar, in your answer:

minimum/minimal/least/smallest/slightest

Required Given the subject's negatives and positives, at the very most, what could someone expect to experience?

Advice

The stress here is on maximum expectations, so describe the highest expectations anyone should have.

Suggestion

Consider using a variation of one of these words, or one like it, in your answer:

maximum/most/greatest/best

### Set 10A—Directions

Congrats, you're almost finished. This final set effectively creates an introduction:

Your key sentence below will hook the readers' attention

Each set answer but the last will pull those readers close and closer to your recommendation, which is that very last one

And as introductions are often very creative, if the mood strikes, you may choose to be mysterious or confessional or scholarly—whatever might engage your readers

Required. A. What could have caused you to expect that?

Advice

Use a pronoun to refer to your subject, or use a synonym to rename it. For example, refer to a book as it or the novel; refer to a speaker as she or he or the lecturer; refer to performers as they or the cast or the musicians.

Click on Example

Example

Of course, the workshop would be excellent, but returning to the campus on a weekend morning would definitely be inconvenient.

A. Optional. After that time, did your expectations change in any degree or in any other way? For example, perhaps you began to look forward more (or less) to experiencing the subject.

Advice

The question is asking about the time between receiving the assignment and actually starting to experience the subject.

Click on Example

Example

As the weekend drew closer, snazzy posters began popping up around campus, generating a buzz, and the class began team-work to prepare for the workshop.

Required. Can you give readers a hint about whether or not the subject came close to meeting your expectations? Do it.

Advice

To keep them reading, aim to be a little mysterious.

Click on Example

Example

Incredibly, the parking lot was jammed on Saturday, and for a good reason.

Optional. Wish to add to the discussion?

Advice

Answer only if you need to—otherwise, your readers may become impatient or bored having to follow unnecessary sentences.

Consider beginning your answer with words of transition. Suggestion

Suggestion

Consider using a transitional expression, such as one of these, to begin your answer:

What is more,/Additionally,/Also,/In addition,

Required. Now, having had the experience, would you recommend the subject to readers?

Advice

Because this is your essay's power statement, it should express your opinion of the subject's value in words appropriate for your course.

Include the full title of your subject.

Capitalize the first, last, and important words (The Decline and Fall of the Roman Empire) in that title.

Also check the Writing Room Help to see if the title should be italicized or placed inside quotation marks.

Once correct, find every other instance of the title in the review and replace it with the correct version.

Click on Example

Example

Contrary to expectations, class members who participated in Smith Company's “Acing School Interviews” gained priceless experience and urge other juniors and seniors to plan on attending its next workshop, on November 25.

### Set 10 B—Directions

Congrats, you're almost finished. This final set effectively creates an introduction:

Your key sentence below will hook the readers' attention

Each set answer but the last will pull those readers close and closer to your recommendation, which is that very last one

And as introductions are often very creative, if the mood strikes, you may choose to be mysterious or confessional or scholarly—whatever might engage your readers

Optional. What second question, this one more closely connected to your subject, could you pose next?

Advice

As long as this question is smaller in scope than the first, you're okay. Don't obsess about devising the most impressive sequence of questions: the reader cares only to follow your lead.

If really stuck, skip this and concentrate on the next question. Don't forget to end with a question mark.

Click on Example

Example

What exactly can be gained from reading a classic novel written centuries ago in a different culture?

Required. And what final question, this time directly about the subject of your review, could now be asked? Don't forget the question mark.

Advice

This last question will draw the reader closer still to the review's specific subject.

Having trouble? Try writing a statement and then putting it in question form, and don't forget the question mark.

Example

More to the point, would a novel by Jane Austen hold any sort of appeal for today's collegiate audience?

Required. Before experiencing the subject, how would you have answered the previous question?

Advice

Readers expect you to answer this last question but just vaguely.

Your answer should hint at what's to come in the review.

Click on Example

Example

It seemed highly unlikely, but worth investigating.

Optional. Add another sentence?

Advice

Use this option, for example, to provide an explanation of your previous answer.

Consider beginning your answer with words of transition. Suggestion

Click on Example

Suggestion

Consider using a transitional expression, such as one of these, to begin your answer:

What is more,/Additionally,/Also,/In addition,

Example

After all, there must be a reason that Austen's novels, considered classics, never go out of print.

Required. Now, having had the experience, would you recommend the subject to your readers?

Advice

Because this is your essay's power statement, it should express your opinion of the subject's value in words appropriate for your course.

Include the subject's full title.

Capitalize the first, last, and important words (The Decline and Fall of the Roman Empire) in that title.

Also check Writing Room Help to see if the title should also be italicized or placed inside quotation marks.

Click on Example

Example

Two weeks and 368 pages later, I can recommend Sense and Sensibility not only to English majors but also to fans of Friends and everyone else who prizes comedy and romance tied together with wit and passion.

While there has been described what is believed to be the preferred embodiment of the present invention, those skilled in the art will recognize that other and further changes and modifications may be made thereto without departing from the spirit of the invention. The preferred embodiment described above is computer-based and/or web-based. However, the invention may be practiced in many other ways. For example, a user could create a writing with the system and/or method by following oral or printed directions, or create an essay, for example, by answering a questionnaire. The system and/or method may be accessed and utilized manually, digitally, or by alternative electronic means (e.g., cellular, satellite, WiFi, etc.); may be described and published in print; may be recorded and published in audio format; the system and/or method may be learned and implemented ad hoc; the system and/or method may be extended (e.g., by creating tertiary-question sets) for creating greater complexity, length, or both; the system and/or method may create other forms of expression and communication; may be shortened or simplified; the system and method may be customized for commercial writing (e.g., briefs, business plans, grant applications); and/or the system and/or method may be used for test preparation (e.g., preparation for SAT by repeated creation of writings of similar length and/or style for essay portion of SAT). In addition, the invention could be combined with voice-recognition software to speed output; could use various markup languages to facilitate data retrieval; may be used to create other forms of expression in communication not described above (e.g., scripts, letters, speeches, dissertations, poetry, recipes, etc.); may be utilized for acquiring, practicing, improving and/or mastering language and rhetorical concepts (e.g., teaching a user how to use a semicolon to separate independent clauses logically by asking two questions each requiring a full clause and directing that the first period between them be replaced with a semicolon), and other changes and modifications.

Therefore, the invention is not limited to the specific details and representative embodiments shown and described herein. Accordingly, persons skilled in this art will readily appreciate that various additional changes and modifications may be made without departing from the spirit or scope of the invention, as defined and differentiated by the following claims.

1. A computer-readable medium having computer-executable instructions for performing a method comprising:
determining a desired writing type;
generating a plurality of primary questions corresponding to said writing type;
receiving answers to one or more of said primary questions;
generating a plurality of secondary questions;
receiving answers to one or more of said secondary questions; and
arranging said answers to said primary questions and said answers to said secondary questions as a function of said writing type;
thereby generating a first writing.

2. The computer-readable medium as set forth in claim 1, further comprising:
receiving revisions to said first writing; and
generating a second writing which incorporates said revisions.

3. The computer-readable medium as set forth in claim 1 wherein said writing type is a review, report, analysis, argument, essay, composition, comparison, narration, description, exposition, classification, definition, illustration, process, biography, term paper, thesis or dissertation.

4. The computer-readable medium as set forth in claim 1 wherein said primary question set comprises a request for a hypothesis.

5. The computer-readable medium as set forth in claim 1 wherein secondary questions are generated only corresponding to primary questions for which an answer is received.

6. The computer-readable medium as set forth in claim 1, further comprising:
generating a key sentence for said first writing corresponding to each of said answers to said primary questions.

7. The computer-readable medium as set forth in claim 1, further comprising:
providing advice corresponding to said primary questions or said secondary questions.

8. The computer-readable medium as set forth in claim 7 wherein said advice comprises a multiple choice suggestion, a writing sample, a template or a glossary.

9. The computer-readable medium as set forth in claim 1, further comprising:
providing a display; and
displaying a preview of said first writing after receiving said answers to said primary questions or said secondary questions.

10. The computer-readable medium as set forth in claim 1, further comprising:
generating an introduction of said first writing as a function of the answer to the last of said primary questions.

11. The computer-readable medium as set forth in claim 1, further comprising:
determining a time period to complete said writing.

12. The computer-readable medium as set forth in claim 11, further comprising:
determining the time remaining in said time period; and
displaying said time remaining in said time period.

13. The computer-readable medium as set forth in claim 1, further comprising:
determining a length for said writing; and
generating said primary questions as a function of said length.

14. The computer-readable medium as set forth in claim 1, further comprising:
determining a preferred length for said writing; and
generating said secondary questions as a function of said preferred length.

15. The computer-readable medium as set forth in claim 1, further comprising:
generating a plurality of tertiary questions corresponding to said answers to said secondary questions;
receiving answers to said tertiary questions; and
arranging said answers to said primary questions, said secondary questions and said tertiary questions as a function of said writing type;
thereby generating a first writing.

16. The computer-readable medium as set forth in claim 1 wherein said primary questions are displayed on an interactive electronic display.

17. The computer-readable medium as set forth in claim 1 wherein said secondary questions are displayed on an interactive electronic display.

18. The computer-readable medium as set forth in claim 1 wherein said first writing is generated in an electronic format compatible with a word processing software.

19. The computer-readable medium as set forth in claim 1, further comprising:
controlling a printing device to print said first writing.

20. The computer-readable medium as set forth in claim 1, further comprising:
maintaining a database of said primary questions and said secondary questions.

21. The computer-readable medium as set forth in claim 1 wherein the method is web-based.

22. The computer-readable medium as set forth in claim 1, further comprising:
receiving bibliographic information associated with one or more of said primary questions or said secondary questions; and
generating a first writing having a listing of references.

23. A method for creating a writing, comprising:
determining a desired writing type;
generating a plurality of primary questions corresponding to said writing type;
receiving answers to one or more of said primary questions;
generating a plurality of secondary questions;
receiving answers to one or more of said secondary questions; and
arranging said answers to said primary questions and said answers to said secondary questions as a function of said writing type;
thereby generating a first writing.

24. The method as set forth in claim 23, further comprising:
receiving revisions to said first writing; and
generating a second writing which incorporates said revisions.

25. The method as set forth in claim 23 wherein said writing type is a review, report, analysis, argument, essay, composition, comparison, narration, description, exposition, classification, definition, illustration, process, biography, term paper, thesis or dissertation.

26. The method as set forth in claim 23 wherein said primary question set comprises a request for a hypothesis.

27. The method as set forth in claim 23 wherein secondary questions are generated only corresponding to primary questions for which an answer is received.

28. The method as set forth in claim 23, further comprising:
generating a key sentence for said first writing corresponding to each of said answers to said primary questions.

29. The method as set forth in claim 23, further comprising:
providing advice corresponding to said primary questions or said secondary questions.

30. The method as set forth in claim 29 wherein said advice comprises a multiple choice suggestion, a writing sample, a template or a glossary.

31. The method as set forth in claim 23, further comprising:
providing a display; and
displaying a preview of said first writing after receiving said answers to said primary questions or said secondary questions.

32. The method as set forth in claim 23, further comprising:
generating an introduction of said first writing as a function of the answer to the last of said primary questions.

33. The method as set forth in claim 23, further comprising:
determining a time period to complete said writing.

34. The method as set forth in claim 33, further comprising:
determining the time remaining in said time period; and
displaying said time remaining in said time period.

35. The method as set forth in claim 23, further comprising:
determining a length for said writing; and
generating said primary questions as a function of said length.

36. The method as set forth in claim 23, further comprising:
determining a preferred length for said writing; and
generating said secondary questions as a function of said preferred length.

37. The method as set forth in claim 23, further comprising:
generating a plurality of tertiary questions corresponding to said answers to said secondary questions;
receiving answers to said tertiary questions; and
arranging said answers to said primary questions, said secondary questions and said tertiary questions as a function of said writing type;
thereby generating a first writing.

38. The method as set forth in claim 23 wherein said primary questions are displayed on an interactive electronic display.

39. The method as set forth in claim 23 wherein said secondary questions are displayed on an interactive electronic display.

40. The method as set forth in claim 23 wherein said first writing is generated in an electronic format compatible with a word processing software.

41. The method as set forth in claim 23, further comprising:
controlling a printing device to print said first writing.

42. The method as set forth in claim 23, further comprising:
maintaining a database of said primary questions and said secondary questions.

43. The method as set forth in claim 23, further comprising:
receiving bibliographic information associated with one or more of said primary questions or said secondary questions; and
generating a first writing having a listing of references.

44. The method as set forth in claim 23 wherein said method is implemented through interactive software.

45. The method as set forth in claim 23 wherein said method is implemented through the internet.
